(19) United States
(12) Patent Application Publication
(10) Pub. No.: US 2020/0169040 A1
(43) Pub. Date: May 28, 2020

(54) CONNECTOR AND CONNECTION STRUCTURE

(71) Applicant: IRISO ELECTRONICS CO., LTD., Yokohama-shi, Kanagawa (JP)

(72) Inventors: Jyunya Sakaue, Yokohama-shi, Kanagawa (JP); Hideki Shioda, Yokohama-shi, Kanagawa (JP); Yoshihito Ohkuma, Yokohama-shi, Kanagawa (JP)

(21) Appl. No.: 16/632,189

(22) PCT Filed: Jul. 17, 2018
(86) PCT No.: PCT/JP2018/026710

§ 371 Date: Jan. 17, 2020

(30) Foreign Application Priority Data
Jul. 20, 2017 (JP) 2017-140987

(51) Int. Cl. H01R 13/631; H01R 13/26; H01R 13/41

(52) U.S. Cl. CPC H01R 13/6315; H01R 13/41; H01R 13/26

(57) ABSTRACT

A connector includes a stationary housing, a movable housing that is movable in a front-rear direction and a left-right direction with respect to the stationary housing, a stationary terminal that is retained at the stationary housing, and a movable terminal that is retained at the movable housing and that includes contact portions configured to achieve electrical continuity with a connection target inserted in a downward direction. The stationary terminal and the movable terminal are mutually in contact and achieve electrical continuity. The stationary terminal and the movable terminal slide against one another while maintaining electrical continuity when the movable housing moves in the front-rear direction or the left-right direction with respect to the stationary housing. The contact portions are configured to contact the connection target from a direction parallel to a planar face of a substrate.

### BACKGROUND

### Technical Field

The present invention relates to a connector and a connection structure.

### Background Art

A connector disclosed in Patent Document 1 is known as a connector capable of absorbing offset in an attachment position of a connection target.

The connector includes a frame shaped housing that is open at the upper side and is fixed to a substrate, and an overhanging beam shaped contact (terminal) with one end retained by the housing. A peaked contact point with an apex oriented toward the opening in the housing is elastically supported by a free end of the contact.

In such a connector, electrical continuity is enabled by pressing a leading end face of a terminal of a connection target against the peaked contact point. Even if an attachment position of the connection target relative to the connector were to become offset, the peaked contact point is able to slide within the range of the leading end face after the leading end face has been pressed against the contact point.

Thus, even if the attachment position of the connection target relative to the connector were to become offset, this offset can be absorbed.

### PATENT LITERATURE

Patent Document 1: Japanese Patent Application Laid-Open (JP-A) No. 2008-170801
Patent Document 2: JP-A No. 2007-018785

### SUMMARY OF INVENTION

### Technical Problem

However, in such a connector, the connection target is in press contact with the connector at all times, and so a load is borne by the substrate where the connector is disposed, such that substrate is liable to warp in its plate thickness direction.

If the substrate were to warp, this could lead to defects in electrical equipment, for example cracks might develop in soldered portions of electrical components disposed on a planar surface of the substrate, or the electrical components themselves might break.

The connector disclosed in Patent Document 2 includes a stationary housing fixed to a substrate, and a movable housing that is separate to the stationary housing. A first fixed portion of a terminal is fixed to the movable housing, a second fixed portion of the terminal is fixed to the stationary housing, and the movable housing is retained so as to allow some lift above a bottom face side of the stationary housing. An elastic portion is elastically deformed between the first fixed portion and the second fixed portion of the terminal such that the movable housing is movable with respect to the stationary housing, enabling positional offset with respect to a connection target to be absorbed as a result.

However, in such a connector, in cases in which the position of the connection target is offset in either of two directions parallel to a planar face of the substrate, the entirety of this positional offset is absorbed by elastic deformation of the elastic portion. Stress thereby concentrates at the elastic portion, such that is a possibility that contact might be lost.

The present invention is proposed to address issues such as the above.

Namely, an object of the present invention is to provide a connector and a connection structure that are capable of absorbing positional offset relative to a connection target, while a terminal is not liable to be damaged and a substrate is not liable to be warped by connection with the connection target.

### Solution to Problem

A connector according to a first aspect includes a stationary housing configured to be fixed to a substrate, a movable housing that is movable in a front-rear direction and a left-right direction with respect to the stationary housing, the front-rear direction and the left-right direction being mutually orthogonal and running parallel to a planar surface of the substrate, a stationary terminal that is retained at the stationary housing, and a movable terminal that is formed separately from the stationary terminal and retained at the movable housing, and that includes a contact portion configured to achieve electrical continuity with a connection target inserted in a downward direction that is a direction toward the substrate out of directions orthogonal to the planar surface of the substrate. The stationary terminal and the movable terminal are mutually in contact and achieving electrical continuity. The stationary terminal and the movable terminal are configured to slide against one another while maintaining electrical continuity when the movable housing moves in the front-rear direction or the left-right direction with respect to the stationary housing. The contact portion is configured to contact the connection target from a direction parallel to the planar face of the substrate.

In this aspect, the connector includes the stationary housing configured to be fixed to the substrate and the movable housing that is movable in the front-rear direction and the left-right direction with respect to the stationary housing. Of these, the stationary terminal is retained at the stationary housing, and the movable terminal is retained at the movable housing. The stationary terminal and the movable terminal are mutually in contact and achieving electrical continuity. The movable terminal includes the contact portion configured to achieve electrical continuity with the connection target.

The stationary terminal and the movable terminal are configured to slide against one another while maintaining electrical continuity when the movable housing moves in the front-rear direction or the left-right direction with respect to the stationary housing. Namely, even when the movable housing moves in either of two directions (the front-rear direction or the left-right direction) parallel to the planar surface of the substrate with respect to the stationary housing, the stationary terminal and the movable terminal slide against one another while maintaining electrical continuity.

Accordingly, stress is less liable to concentrate on the terminal, enabling damage to the terminal to be suppressed compared to a conventional connector in which all positional offset is absorbed by elastic deformation of an elastic portion when positional offset arises in either of two directions parallel to the planar surface of a substrate.

Further, the contact portion of the movable terminal that achieves electrical continuity with the connection target is in contact with the connection target along a direction parallel to the planar surface of the substrate (namely, along a direction orthogonal to an insertion direction of the connection target).

This enables the load borne by the substrate accompanying connection of the connection target to be reduced compared to a conventional connector in which a contact portion makes contact with a connection target from underneath, this being a direction orthogonal to the substrate, and receives downward direction (a direction orthogonal to the substrate) counterforce from the connection target to ensure contact pressure. This enables the connector to be made less liable to warp the substrate after being connected to the connection target.

A connector according to a second aspect is the first aspect, wherein the connector includes an upper limiting portion that limits a movement range of the movable housing with respect to the stationary housing in an upward direction that is a direction to remove the connection target. The upper limiting portion is integrally formed with the stationary housing, and at least one of the stationary terminal or the movable terminal is held in an elastically deformed state at all times by the upper limiting portion, with elastic force due to the elastic deformation acting along a direction to place the stationary terminal and the movable terminal in pressing contact so as to achieve electrical continuity.

In this aspect, the connector includes the upper limiting portion that limits the movement range of the movable housing with respect to the stationary housing in the upward direction (namely, in the direction in which the connection target is removed). The upper limiting portion holds at least one of the stationary terminal or the movable terminal in an elastically deformed state at all times, and elastic force due to this elastic deformation acts along a direction placing the stationary terminal and the movable terminal in pressing contact so as to achieve electrical continuity. This stabilizes the electrical continuity between the stationary terminal and the movable terminal.

Further, since the upper limiting portion is combined with the stationary housing into an integral unit, load received by the upper limiting portion due to limiting the range of upward direction movement of the movable housing is transmitted to the stationary housing.

As this load is upward load, downward load received by the stationary housing from the movable terminal through the stationary terminal is cancelled out. As a result, the load transmitted toward the substrate from the connector is reduced.

Thus, in this aspect, electrical continuity between the stationary terminal and the movable terminal is stabilized, and warping of the substrate is able to be prevented.

A connector according to a third aspect is the second aspect, further including a fixing clip configured to fix the stationary housing to the substrate. The upper limiting portion is integrally formed as part of the fixing clip.

In this aspect, the upper limiting portion that limits the range of upward direction movement of the movable housing with respect to the stationary housing is integrally formed as part of the fixing clip for fixing the stationary housing to the substrate. Thus, a mounting operation is simplified compared to configurations in which the upper limiting portion is formed separately from a member for fixing a stationary housing to a substrate.

A connector according to a fourth aspect is any one of the first aspect to the third aspect, wherein the movable terminal includes a movable-side sliding portion configured by a portion of the movable terminal that slides against the stationary terminal and has a plate thickness direction along an up-down direction, and a U-shaped portion with a U-shaped cross-section profile that is positioned above the movable-side sliding portion, and that includes a bottom plate portion connected to the movable-side sliding portion and a pair of side plate portions. The contact portions are formed as a pair to leading end sides extending upward from the pair of side plate portions so as to pinch and make contact with the connection target. The movable-side sliding portion has a greater dimension than the U-shaped portion in the left-right direction that is a direction in which the pair of side plate portions face one another.

In this aspect, the movable-side sliding portion, this being the portion of the movable terminal that makes contact with the stationary terminal, has its plate thickness direction in the up-down direction, and the U-shaped portion is positioned above the movable-side sliding portion. The U-shaped portion includes the bottom plate portion and the pair of side plate portions, and the bottom plate portion is connected to the movable-side sliding portion. The contact portions that make contact with the connection target are formed in a pair at ends extending upward from the pair of side plate portions so as to pinch and make contact with the connection target. The left-right direction (the direction in which the pair of side plate portions face one another) dimension of the movable-side sliding portion is greater than that of the U-shaped portion, enabling a large amount of left-right direction positional offset of the connection target to be absorbed.

A connector according to a fifth aspect is the fourth aspect, wherein the movable terminal further includes a first fixed portion that extends upward from the bottom plate portion of the U-shaped portion and is press fitted and fixed to the movable housing. Base portions of the pair of side plate portions of the U-shaped portion are not hidden by the movable-side sliding portion when the movable terminal is viewed from below.

In this aspect, the first fixed portion that is press fitted and fixed to the movable housing extends upward from the bottom plate portion of the U-shaped portion. In a bottom face view looking at the movable terminal from below, the base portions of the pair of side plate portions of the U-shaped portion are not hidden by the movable-side sliding portion. Accordingly, the first fixed portion is able to be press fitted into the movable housing in an appropriate manner by pushing the base portions of the pair of side plate portions that are not hidden by the movable-side sliding portion upward from a lower side of the movable terminal.

A connector according to a sixth aspect is the fourth or the fifth aspect, wherein latching projections are formed at leading end sides of the pair of side plate portions, and the pair of side plate portions of the U-shaped portion configure second fixed portions that are press fitted and fixed to the movable housing.

In this aspect, the latching projections are formed at the leading end sides of the pair of side plate portions. Accordingly, the pair of side plate portions of the U-shaped portion configure second fixed portions that are press fitted and fixed to the movable housing.

This enables wobble of the movable terminal with respect to the movable housing in a direction about an up-down direction axis of rotation to be suppressed.

A connector according to a seventh aspect is any one of the fourth to the sixth aspect, wherein a pair of guide portions that have a greater plate width dimension than the contact portions are formed further to an upper side than the contact portions.

In this aspect, the guide portions that have a greater width dimension than the contact portions are formed further to the upper side than the contact portions, enabling the connection target to be guided so as to achieve electrical continuity in an appropriate manner.

A connection structure according to an eighth aspect includes the connector according to the second aspect and the connection target connected to the connector. The movable housing is positioned at an upward limit position by the upper limiting portion.

In this aspect, the movable housing is positioned at the upward limit position by the upper limiting portion, and so upward load acts on the stationary housing through the upper limiting portion. Downward load on the stationary housing due to elastic force from the terminal is cancelled out by this load, thereby reducing load placed on the substrate by the stationary housing. This enables a connection structure in which the substrate is not liable to warp.

### Advantageous Effects of Invention

As described above, the present invention has the excellent advantageous effect of enabling absorbing positional offset relative to the connection target to be absorbed, while the terminal is not liable to be damaged and the substrate is not liable to be warped by connection with the connection target.

### BRIEF DESCRIPTION OF DRAWINGS

FIG. 1A is a perspective view of an assembled connector.

FIG. 1B is a side view of an assembled connector.

FIG. 1C is a perspective view cross-section of an assembled connector taken along a plane orthogonal to a connector width direction.

FIG. 1D is a perspective view cross-section of an assembled connector taken along a plane orthogonal to a connector front-rear direction.

FIG. 1E is a cross-section of an assembled connector taken along a plane orthogonal to a connector width direction.

FIG. 1F is an exploded perspective view of a connector.

FIG. 2A is an exploded perspective view of stationary-side member.

FIG. 2B is a perspective view of a stationary-side member.

FIG. 2C is a side view of a stationary-side member.

FIG. 2D is a side view cross-section of a stationary-side member.

FIG. 3A is an exploded perspective view of a movable-side member.

FIG. 3B is a side view cross-section of a movable-side member.

FIG. 4A is a perspective view illustrating a state in which a stationary terminal is retained at a stationary housing.

FIG. 4B is a perspective view illustrating a state in which a stationary terminal is retained at a stationary housing as seen from another angle.

FIG. 4C is a plan view illustrating a state in which a stationary terminal is retained at a stationary housing.

FIG. 5A is a perspective view of a stationary terminal.

FIG. 5B is a side view of a stationary terminal.

FIG. 6A is a perspective view of a stationary housing.

FIG. 6B is a perspective view of a stationary housing as seen from another angle.

FIG. 6C is a plan view of a stationary housing.

FIG. 6D is a side view of a stationary housing.

FIG. 7A is a perspective view of fixing clips.

FIG. 7B is a side view of a fixing clip.

FIG. 8A is a perspective view of a movable terminal.

FIG. 8B is a perspective view of a movable terminal as seen from another angle.

FIG. 8C is a bottom face view of a movable terminal.

FIG. 9A is a perspective view of a movable housing.

FIG. 9B is a side view cross-section of a movable housing.

FIG. 10A is a perspective view of a movable shield.

FIG. 10B is a side view cross-section of a movable shield.

FIG. 11 a cross-section of a connection target.

FIG. 12 is a cross-section of a connection structure in which a connector and a connection target have been connected.

### DESCRIPTION OF EMBODIMENTS

Explanation follows regarding an exemplary embodiment of the present invention.

Note that the arrows X, Y, and Z illustrated in the drawings are respectively used to indicate a connector front direction, one side (a left side) in a connector width direction, and a connector upward direction in the following explanation. Further, unless specifically stated otherwise, the terms front-rear, up-down, and width (left-right) are used to indicate front-rear in a connector front-rear direction, up-down in a connector up-down direction, and width (left-right) in the connector width direction (left-right direction).

Overview

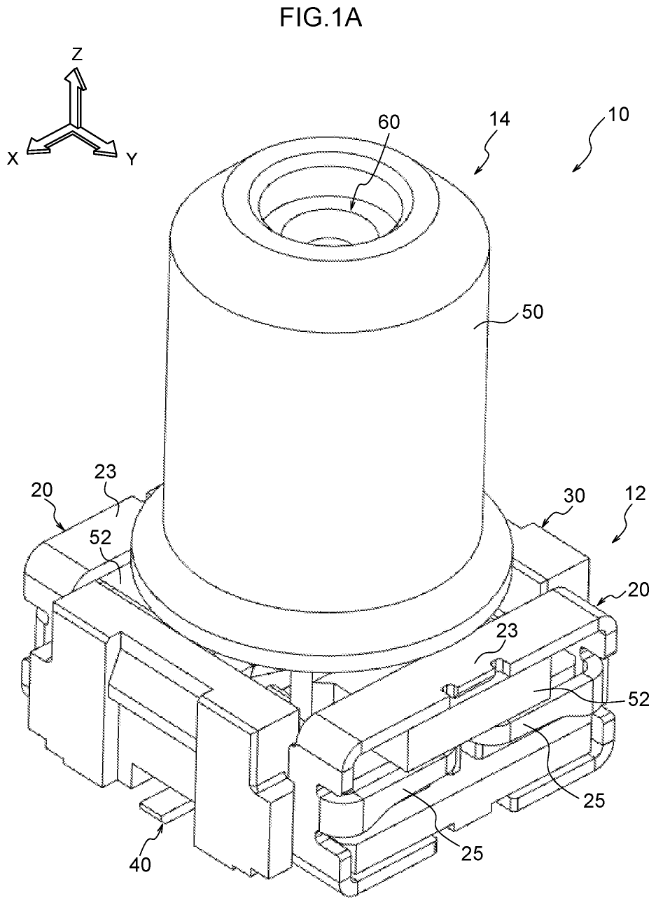

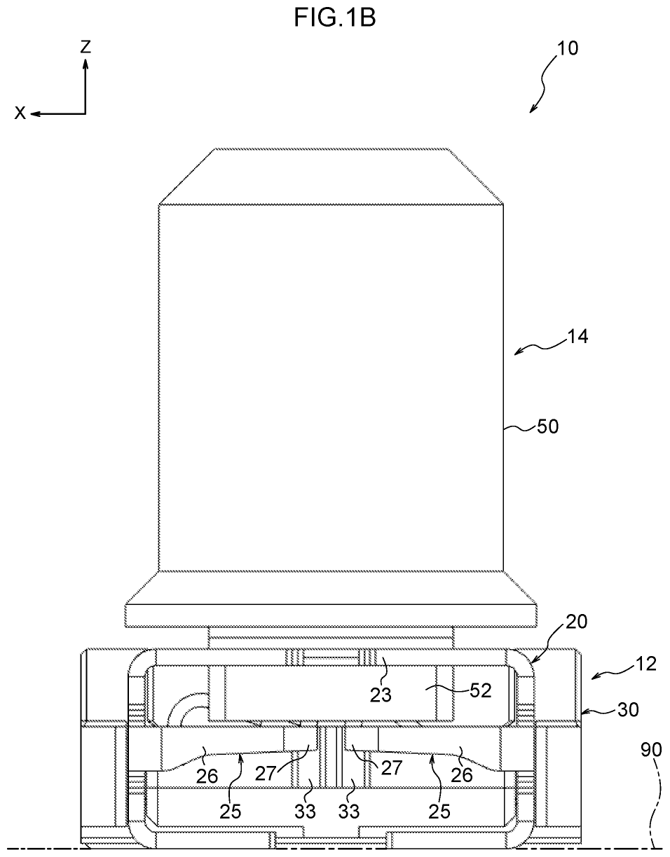

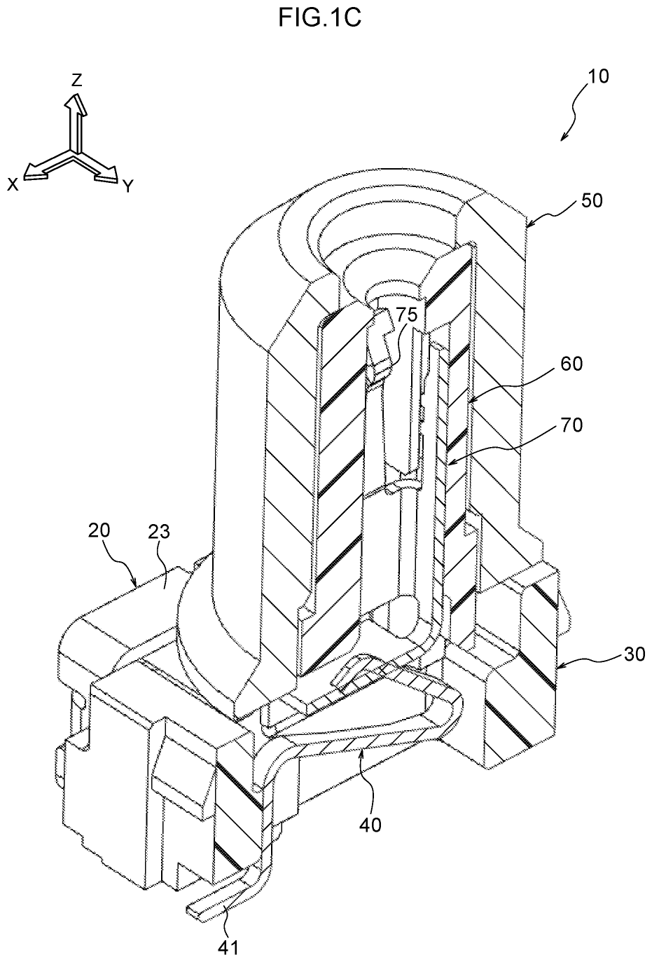

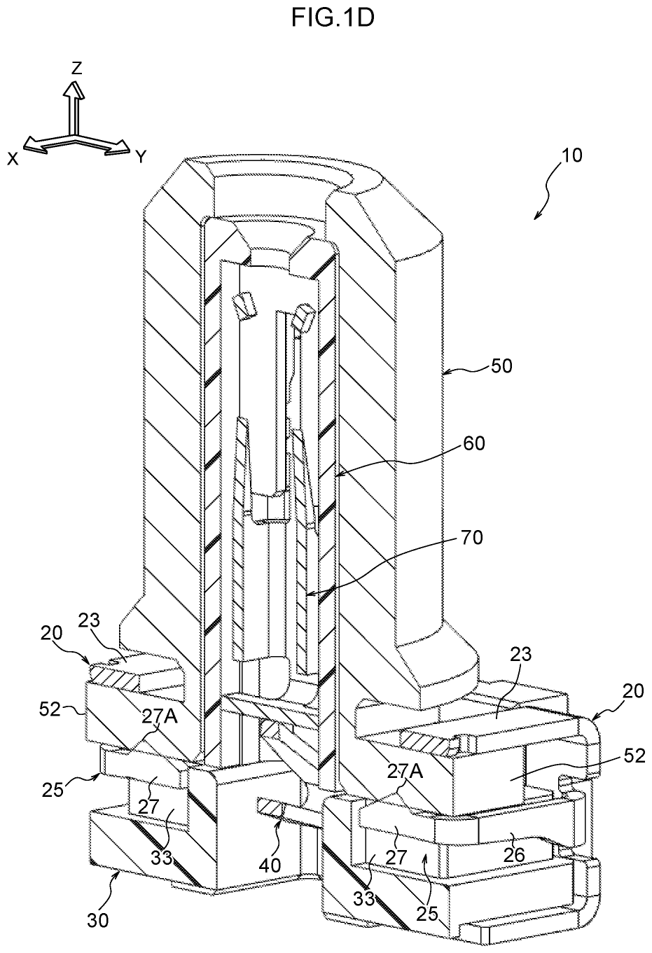

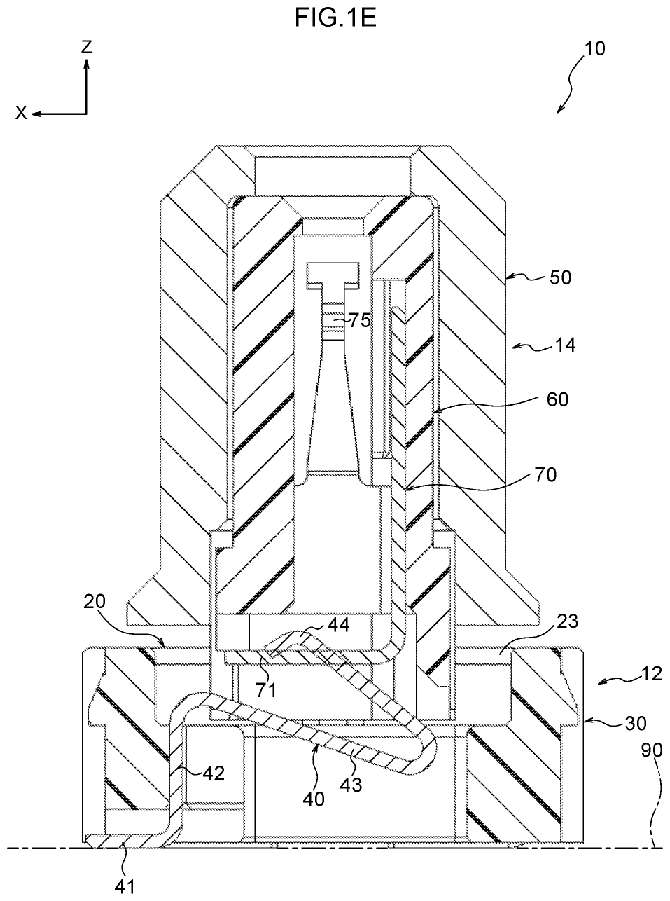

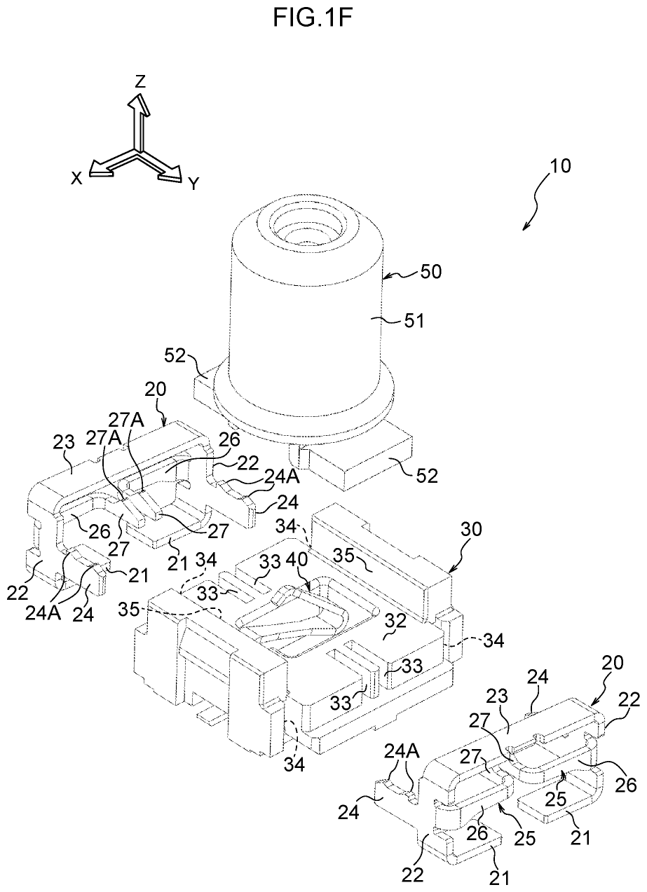

FIG. 1A to FIG. 1E illustrate a connector 10 of an exemplary embodiment in an assembled state. FIG. 1F illustrates the connector 10 in an exploded state.

The connector 10 is broadly configured by a stationary-side member 12 that is fixed to a substrate 90 (see FIG. 1B, FIG. 1E) and a movable-side member 14 that is movable through a given range of motion with respect to the stationary-side member 12.

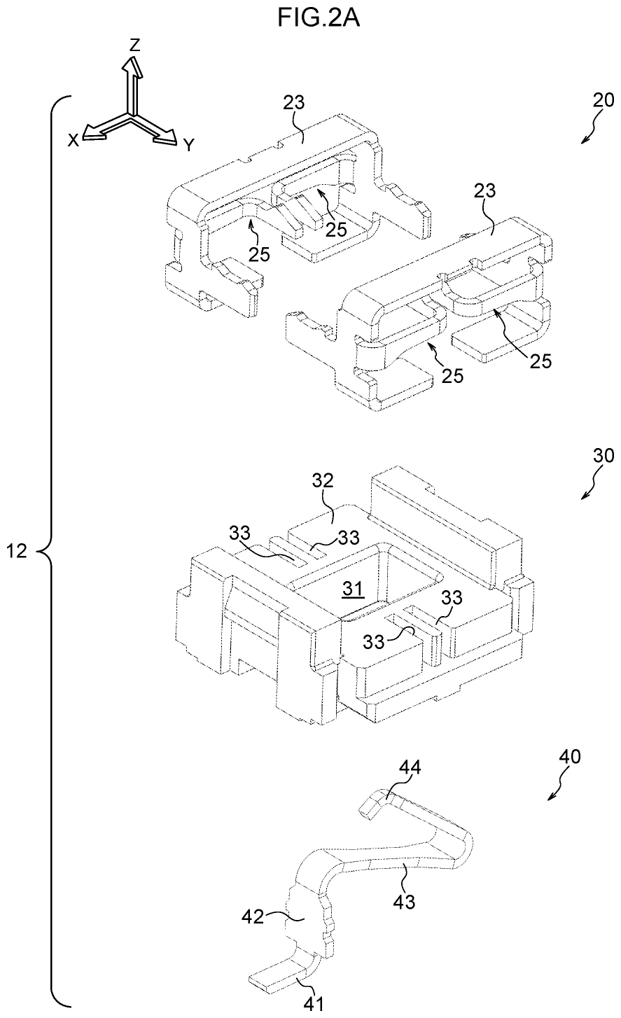

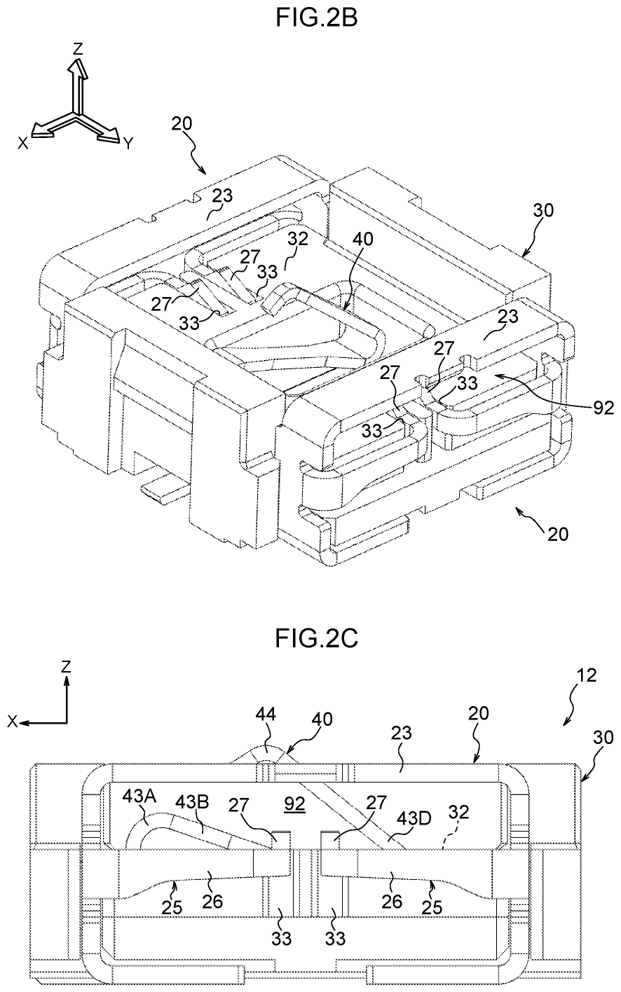

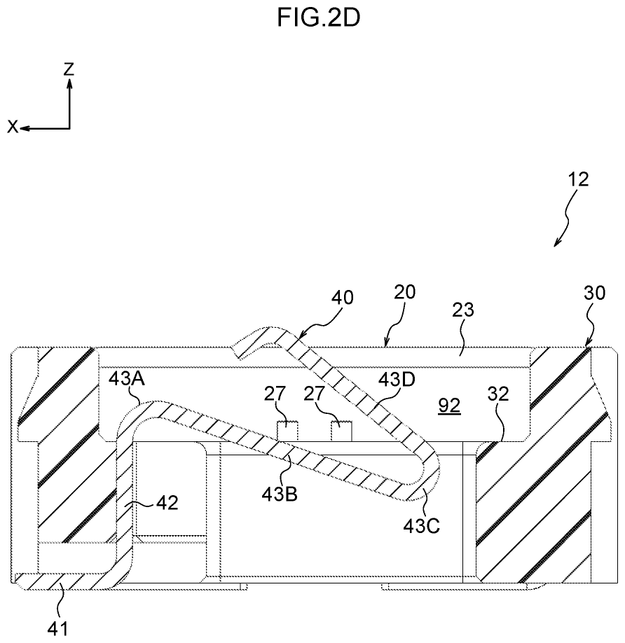

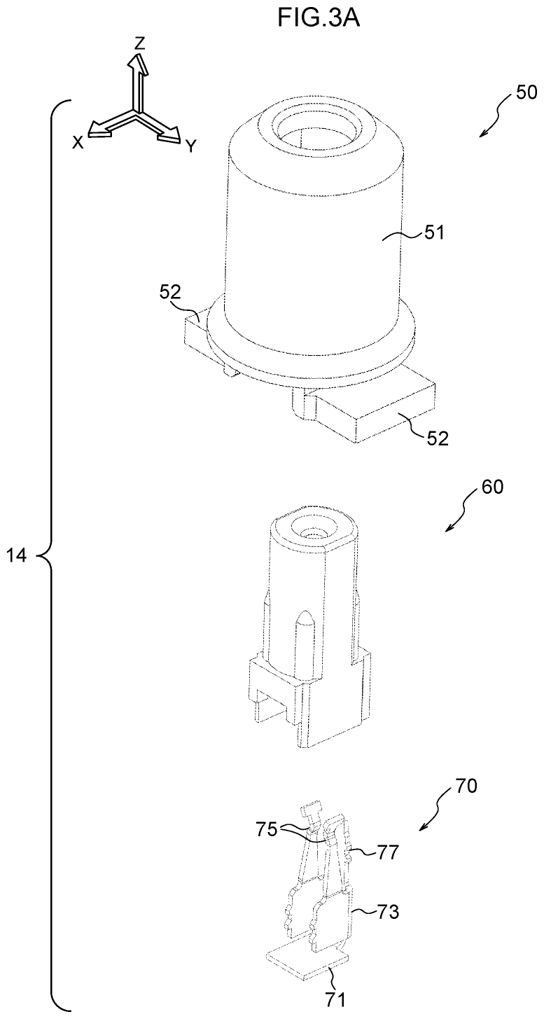

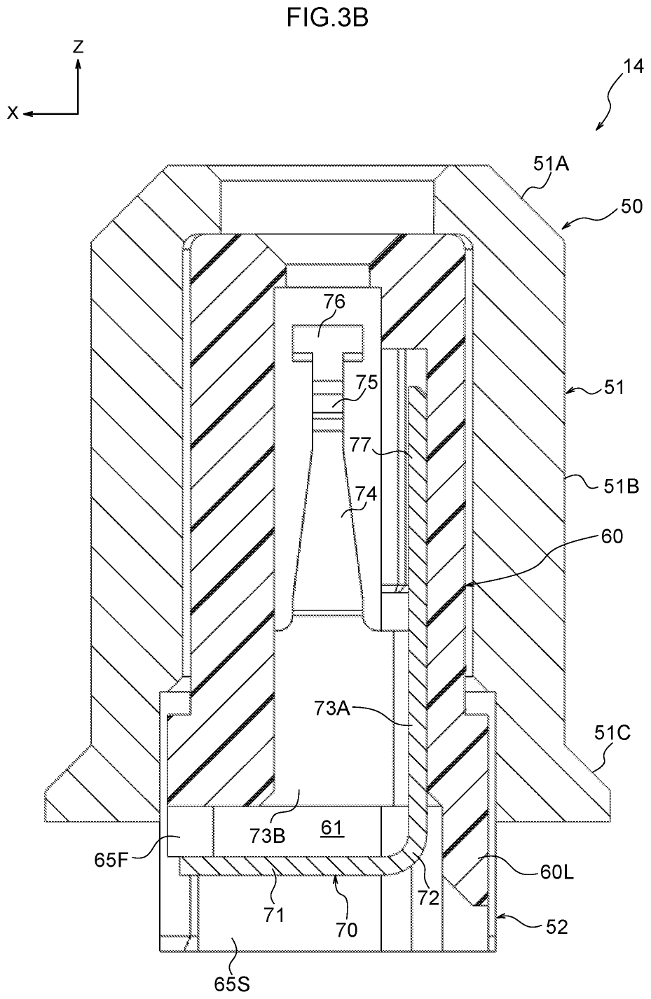

As illustrated in FIG. 2A, the stationary-side member 12 is configured by fixing clips 20, a stationary housing 30, and a stationary terminal 40. As illustrated in FIG. 3A, the movable-side member 14 is configured by a movable shield 50, a movable housing 60, and a movable terminal 70.

When the connector 10 is in an assembled state, the stationary terminal 40 and portions of the fixing clips 20 (elastic spring sections 25), for example, are elastically deformed. However, in the drawings, (for example FIG. 1C to FIG. 1E), each of these components is illustrated in a free state (a state not elastically deformed) for the sake of simplicity. Sections where such components are illustrated overlapping with one another indicate places where, in practice, one or both of these overlapping components is elastically deformed.

Detailed explanation follows regarding the configuration of various portions.

Stationary Housing 30

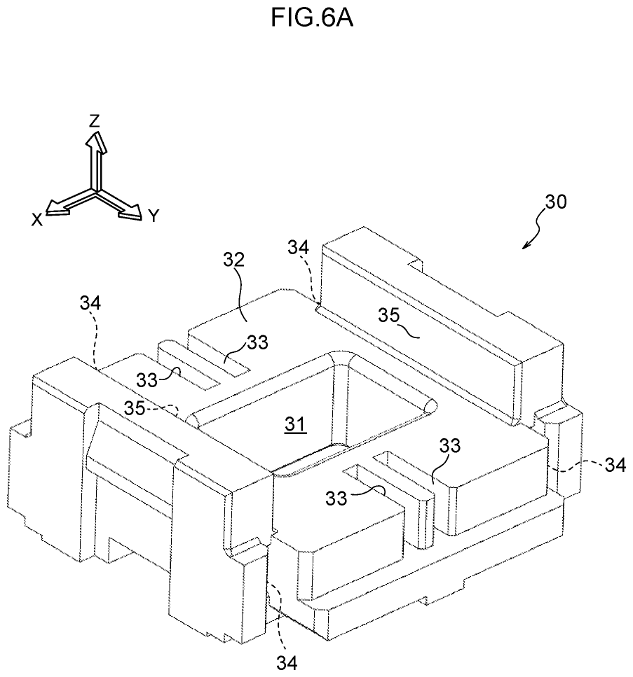

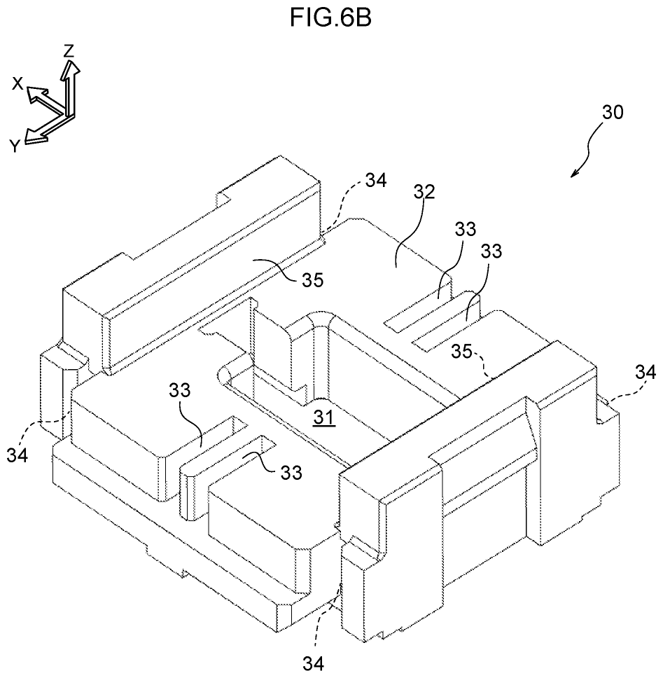

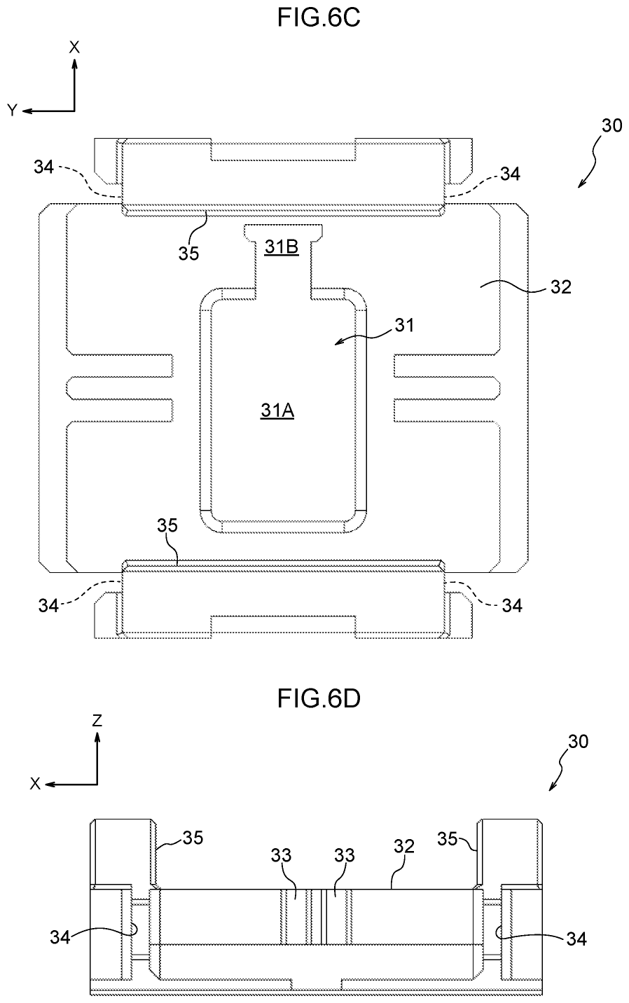

FIG. 6A to FIG. 6D illustrate the stationary housing 30. The stationary housing 30 is a member that is fixed to the substrate 90. Specifically, as illustrated in FIG. 2B, the stationary housing 30 is fixed to the substrate 90 by two of the fixing clips 20. The stationary housing 30 is configured from an insulator such as a synthetic resin.

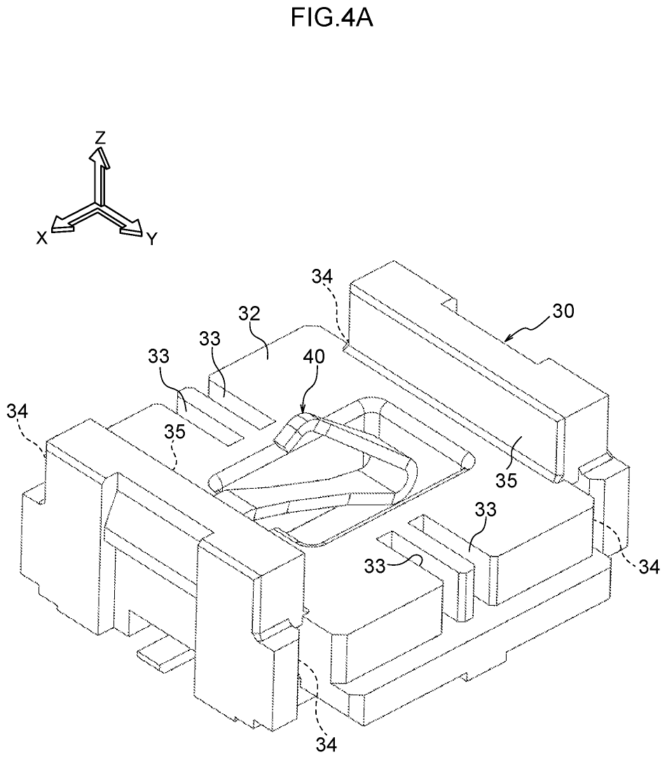

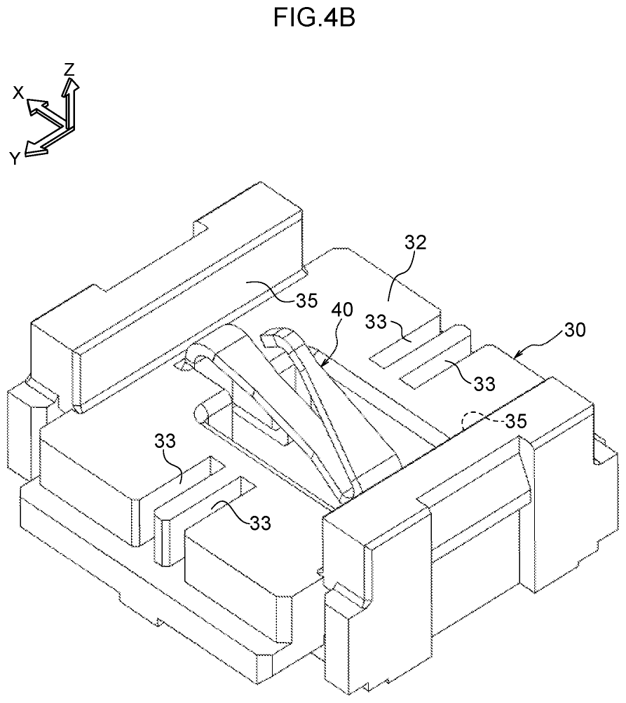

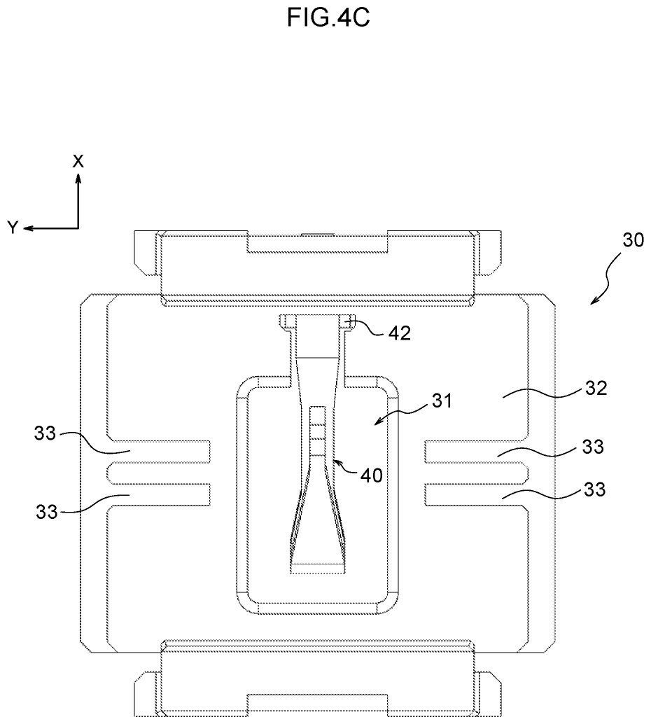

The stationary housing 30 includes a terminal-retaining portion 31 that retains the stationary terminal 40. The terminal-retaining portion 31 is configured by a through hole that passes through the stationary housing 30 in the up-down direction. The stationary terminal 40 is retained at the terminal-retaining portion 31 of the stationary housing 30 as illustrated in FIG. 1F and FIG. 4A to FIG. 4C by pressing the stationary terminal 40 into the stationary housing 30 from below.

As illustrated in FIG. 6C, the terminal-retaining portion 31 is configured by a main body portion 31A that has a substantially rectangular shape in plan view, and by a press-fit portion 31B that widens toward the front from a width direction center of the main body portion 31A. The main body portion 31A has a rectangular shape with its length direction running along the front-rear direction in plan view. The press-fit portion 31B is a portion formed with a smaller width than the main body portion 31A. A front end portion of the press-fit portion 31B is formed slightly wider, and a fixed portion 42 of the stationary terminal 40 is press fitted therein (see FIG. 4C).

The stationary housing 30 includes a limiting face portion 32 that abuts part of the movable-side member 14 (limited portions 52 of the movable shield 50) so as to limit the range of downward direction movement of the movable-side member 14. The limiting face portion 32 is a face on the upper side of the stationary housing 30, and is a planar surface having a normal pointing in an upward direction. The limiting face portion 32 extends in the front-rear direction and the left-right direction from the upper edge of the terminal-retaining portion 31 through hole.

Recesses 33 are formed in the limiting face portion 32 into which stationary-side contact portions 27 of the fixing clips 20 are fit (see FIG. 2B also). The recesses 33 are formed set downward from the limiting face portion 32, and are open at the upper side. In addition to at the upper side, the recesses 33 are also open at the width direction outsides thereof. The recesses 33 are formed in both the left and right sides of the stationary housing 30, with two recesses 33 being formed in each left and right side for a total of four recesses 33.

The stationary housing 30 includes fixing clip holders 34 for combining the stationary housing 30 and the fixing clips 20 into an integral unit. Plural of the fixing clip holders 34 (four, in the present exemplary embodiment) are formed. The fixing clip holders 34 are formed in the vicinity of the four corners of the stationary housing 30 that has a substantially rectangular shape in plan view. The fixing clip holders 34 are holes that open toward the width direction outsides of the stationary housing 30. Two press-fit portions 24 of a fixing clip 20 are press fitted into the two right-side fixing clip holders 34 from the right side of the stationary housing 30, and two press-fit portions 24 of a fixing clip 20 are press fitted into the two left-side fixing clip holders 34 from the left side of the stationary housing 30. The fixing clips 20 and the stationary housing 30 are thereby combined into an integral unit.

The stationary housing 30 further includes front and rear upright face portions 35. The upright face portions 35 are faces that extend upward from a front end and a rear end of the limiting face portion 32. The upright face portions 35 are planar surfaces that have normals pointing in directions toward the front-rear direction center.

Fixing Clips 20

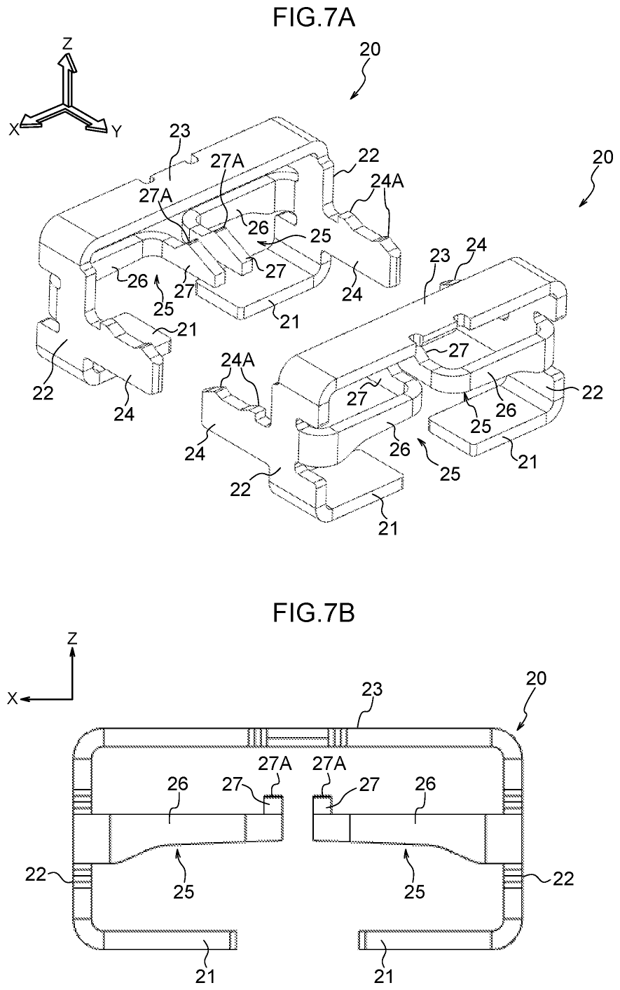

FIG. 7A illustrates the two fixing clips 20. The fixing clips 20 are components for fixing the stationary housing 30 to the substrate 90. The fixing clips 20 are also members for limiting the range of movement of the movable-side member 14. The fixing clips 20 further function as a stationary shield for grounding the movable shield 50 that shields the movable terminal 70.

The fixing clips 20 include substrate-fixed portions 21 that are soldered and fixed to the substrate 90 and that ground the fixing clips 20. The substrate-fixed portions 21 are oriented with their plate thickness directions in the up-down direction, and are formed in front-rear pairs. A front vertical wall portion 22 is formed extending upward from a front end of each front substrate-fixed portion 21, and a rear vertical wall portion 22 is formed extending upward from a rear end of each rear substrate-fixed portion 21. The vertical wall portions 22 are oriented with their plate thickness directions in the front-rear direction.

The fixing clips 20 each include an upper wall portion 23. The upper wall portions 23 link together upper ends of the front and rear vertical wall portions 22 along the front-rear direction. Each upper wall portion 23 is oriented with its plate thickness direction in the up-down direction. The upper wall portions 23 abut part of the movable-side member 14 (the limited portions 52 of the movable shield 50), thereby functioning as an upper limiting portion that limits a range of upward direction movement of the movable-side member 14.

The fixing clips 20 each include the front and rear press-fit portions 24 for combining the fixing clips 20 and the stationary housing 30 into an integral unit. The press-fit portions 24 extend toward a connector width direction center from up-down direction intermediate portions of the front and rear vertical wall portions 22. The press-fit portions 24 are configured with their plate thickness directions in the connector front-rear direction. Latching projections 24A are formed on one plate width direction side (connector upper side) of each press-fit portion 24. The press-fit portions 24 are press fitted into the fixing clip holders 34 of the stationary housing 30.

The fixing clips 20 each include the elastic spring sections 25. A front and rear pair of the elastic spring sections 25 extend from up-down direction intermediate portions of the front and rear vertical wall portions 22. Each elastic spring section 25 is configured by an elastic support portion 26 and a stationary-side contact portion 27.

The elastic support portions 26 elastically support the stationary-side contact portions 27, and the stationary-side contact portions 27 elastically contact part of the movable-side member 14 (the limited portions 52 of the movable shield 50) from the lower side (see FIG. 1D). The elastic support portions 26 extend along the connector front-rear direction toward the connector front-rear direction center. The stationary-side contact portions 27 extend from leading ends of the elastic support portions 26 toward the connector width direction center. The elastic support portions 26 and the stationary-side contact portions 27 are both oriented with their plate thickness directions in a connector horizontal direction, and a bent portion is formed between respective elastic support portions 26 and stationary-side contact portions 27. The stationary-side contact portions 27 are oriented with their plate thickness directions in the connector front-rear direction. The plate width of each stationary-side contact portion 27 varies according to the position along the extension direction thereof, with an apex 27A that protrudes upward being formed by the variations in plate width.

The plate width dimension (connector up-down dimension) of each elastic support portion 26 is largest in the vicinity of its base, and the plate width dimension of each elastic support portion 26 is smallest in the vicinity of its leading end. The portion of each vertical wall portion 22 where the respective elastic spring section 25 extends therefrom has a smaller plate width dimension (connector width direction). Specifically, a connector width direction outside portion of each vertical wall portion 22 is set back toward the connector width direction inside.

As illustrated in FIG. 2C and FIG. 2D, a gap 92 is formed between the limiting face portion 32 of the stationary housing 30 and each of the upper wall portions 23 of the left and right fixing clips 20.

Stationary Terminal 40

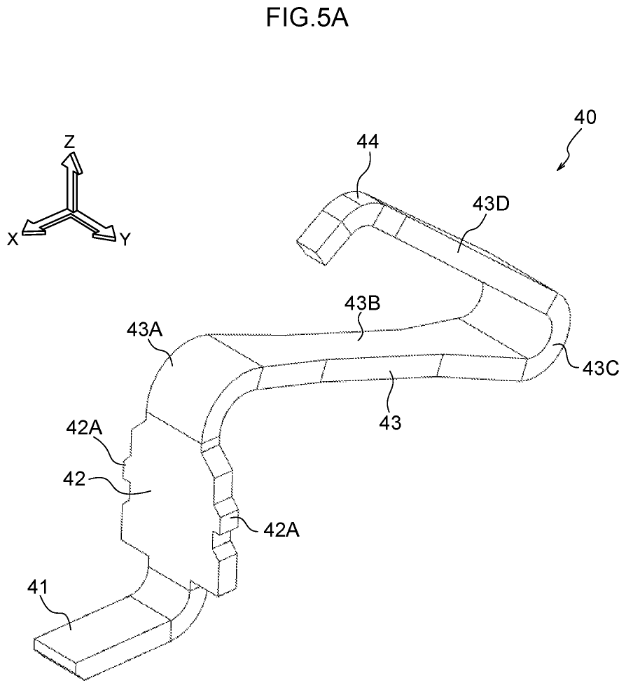

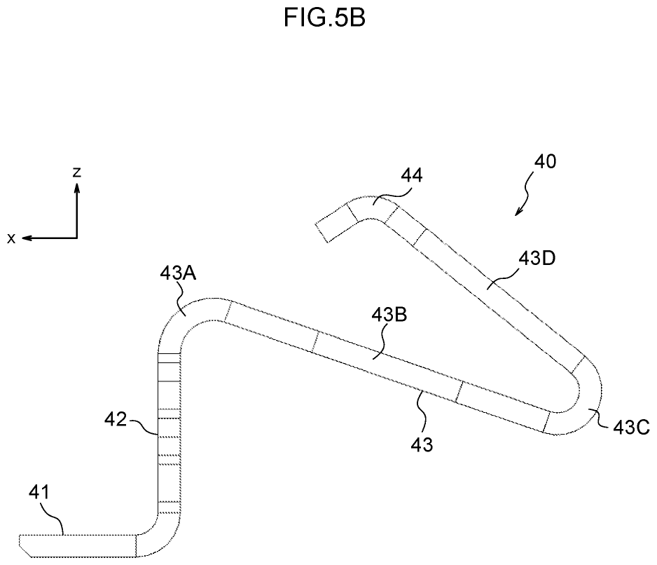

FIG. 5A and FIG. 5B illustrate the stationary terminal 40. The stationary terminal 40 is a signal terminal. A metal sheet blank is punched, and then bent, to form the stationary terminal 40. Accordingly, a front face and a rear face (faces on either side in the plate thickness direction) of the stationary terminal 40 are configured by smoother faces than faces that are formed by punching (faces connecting the front face and the rear face to one another, punch-sheared faces). In the present specification, the front face and the rear face of the stationary terminal 40 are referred to as smooth faces. In the following, of the smooth faces of the stationary terminal 40, the smooth face on the side that makes contact with the movable terminal 70 is the front face, and the smooth face on the opposite side is the rear face.

In sequence from one end to the other end, the stationary terminal 40 includes a substrate-connected portion 41, the fixed portion 42, a spring section 43, and a stationary-side sliding portion 44.

The substrate-connected portion 41 is a portion that is connected to a land pattern or the like on the substrate 90 through soldering. The substrate-connected portion 41 is oriented with its plate thickness direction in the up-down direction, and extends rearward from one end to the other end.

The fixed portion 42 is a portion that is press-fitted into and fixed to the press-fit portion 31B of the stationary housing 30 (see FIG. 6C, FIG. 4C). The fixed portion 42 is oriented with its plate thickness direction in the front-rear direction, and extends upward from one end to the other end. A latching projection 42A is formed on each plate width direction side (each connector width direction side) of the fixed portion 42. The latching projections 42A bite into the stationary housing 30, thereby fixing the fixed portion 42 to the press-fit portion 31B of the stationary housing 30 such that the stationary terminal 40 is retained at the stationary housing 30.

The spring section 43 is a portion of the stationary terminal 40 that has been formed so as to more readily undergo elastic deformation. Specifically, in cases in which a downward load is applied to the stationary-side sliding portion 44 of the stationary terminal 40, the spring section 43 elastically deforms such that the stationary-side sliding portion 44 is displaced downward. In sequence from one end to the other end, the spring section 43 includes a first bent portion 43A, a first straight portion 43B, a second bent portion 43C, and a second straight portion 43D.

The first bent portion 43A is bent toward a plate thickness direction front face side such that it has a profile that curves convexly upward. The direction of extension of the first bent portion 43A changes by at least 90° (approximately 110°) from one end to the other end.

As illustrated in FIG. 2D, in a state in which the stationary terminal 40 is retained at the stationary housing 30 (and is in a state not elastically deformed), the height direction position of the first bent portion 43A is above that of the limiting face portion 32 of the stationary housing 30. In this state, the front-rear direction position of the first bent portion 43A is also in front of the stationary-side contact portions 27 of the fixing clips 20.

The first straight portion 43B is oriented with its plate thickness direction in substantially the up-down direction, and extends in a straight line from one end to the other end in a downward incline toward the rear.

The second bent portion 43C is bent toward a plate thickness direction rear face side such that it has a profile that curves convexly substantially rearward. The direction of extension of the second bent portion 43C changes by nearly 180° (approximately 170°) from one end to the other end, such that the second bent portion 43C extends obliquely upward and to the front at its other end.

As illustrated in FIG. 2D, in a state in which the stationary terminal 40 is retained at the stationary housing 30 (and is in a state not elastically deformed), the height direction position of the second bent portion 43C is substantially the same as, or below, that of the limiting face portion 32 of the stationary housing 30. In this state, the front-rear direction position of the second bent portion 43C is at the rear side of the stationary-side contact portions 27 of the fixing clips 20.

The second straight portion 43D is oriented such that its plate thickness direction is a direction angled with respect to the up-down direction and the front-rear direction, and extends from one end toward the other end in an upwardly inclined straight line with respect to the forward direction (i.e. in a direction angled upward and toward the front).

As illustrated in FIG. 2D, in a state in which the stationary terminal 40 is retained at the stationary housing 30 (and is in a state not elastically deformed), the second straight portion 43D is positioned above the limiting face portion 32 of the stationary housing 30.

The stationary-side sliding portion 44 is a portion that makes sliding contact with part of the movable terminal 70 (a movable-side sliding portion 71). The stationary-side sliding portion 44 is bent toward the plate thickness direction rear face side such that it has a profile that curves convexly upward. The front face (smooth face) of the stationary-side sliding portion 44, this being the face at the upper side, thereby curves convexly upward. The convexly curved portion of the smooth face of the stationary-side sliding portion 44 makes contact with the movable-side sliding portion 71 of the movable terminal 70 from the lower side.

As illustrated in FIG. 2D, in a state in which the stationary terminal 40 is retained at the stationary housing 30 (and is in a state not elastically deformed), the stationary-side sliding portion 44 is positioned above the limiting face portion 32 of the stationary housing 30 and also above the upper wall portions 23 of the fixing clips 20.

In the assembled state, upward load (elastic force) from the stationary-side sliding portion 44 acts on the movable-side sliding portion 71. Namely, while the fixed portion 42 of the stationary terminal 40 is fixed to the press-fit portion 31B of the stationary housing 30, the stationary-side sliding portion 44 of the stationary terminal 40 bears downward load from (the movable terminal 70 of) the movable-side member 14. The spring section 43 of the stationary terminal 40 is elastically deformed thereby. Elastic force from the stationary terminal 40 (and elastic force from the fixing clips 20) presses the movable-side member 14 upward such that the limited portions 52 of the movable shield 50 adopt a state pressed against the upper wall portions 23 (upper limiting portion) of the fixing clips 20 (see FIG. 1B and FIG. 1D).

Movable Terminal 70

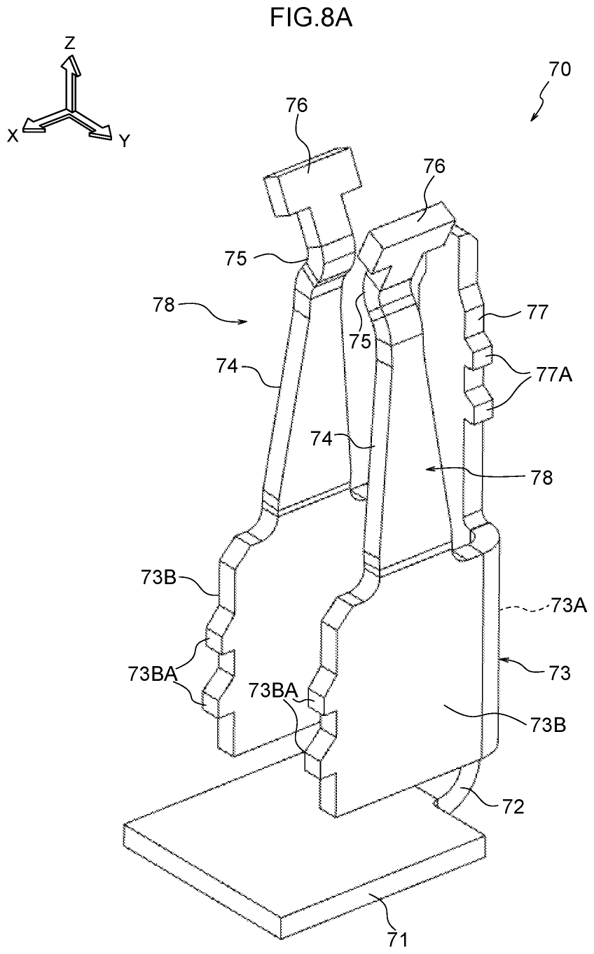

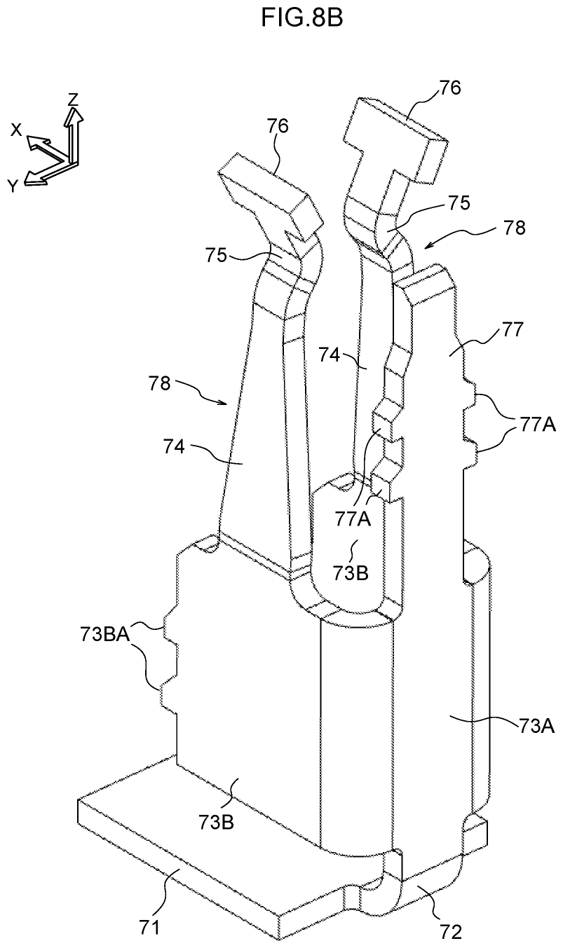

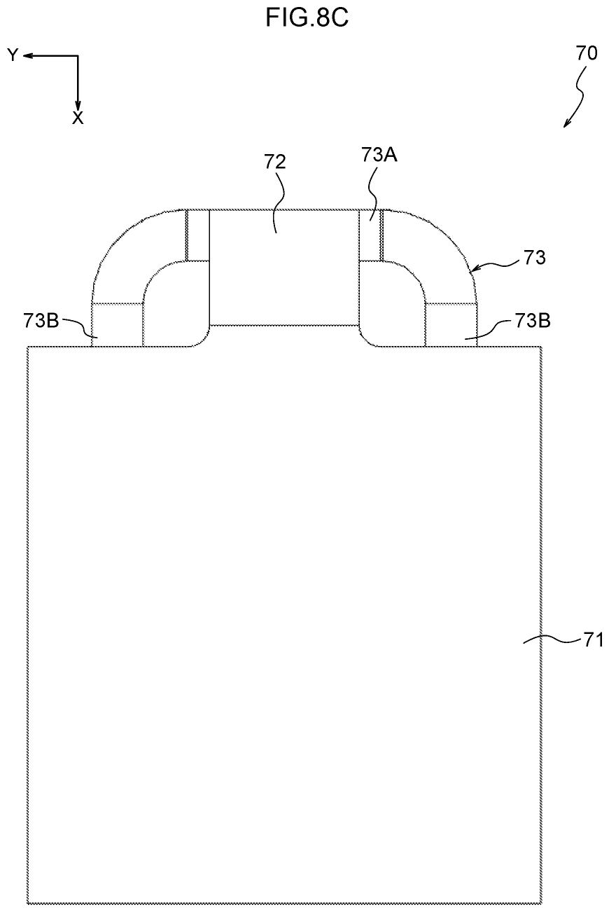

FIG. 8A to FIG. 8C illustrate the movable terminal 70. The movable terminal 70 is a signal terminal. A metal sheet blank is punched, and then bent, to form the movable terminal 70. Accordingly, a front face and a rear face (faces on each side in the plate thickness direction) of the movable terminal 70 are configured by smoother faces than faces that are formed by punching (faces connecting the front face and the rear face to one another, punch-sheared faces). In the present specification, the front face and the rear face of the movable terminal 70 are referred to as smooth faces. Note that of the smooth faces of the movable terminal 70, the face on the side that makes contact with a connection target 80 is the front face, and the face on the opposite side is the rear face.

The movable terminal 70 includes the movable-side sliding portion 71, a U-shaped portion 73, a first fixed portion 77, and contact portions 75 as main configuration elements.

The movable-side sliding portion 71 is a portion that makes sliding contact with the stationary-side sliding portion 44 of the stationary terminal 40. The movable-side sliding portion 71 has a flat plate shape that is oriented with its plate thickness direction in the up-down direction, and is rectangular shaped in plan view. The smooth face on the lower side of the movable-side sliding portion 71 makes contact with the smooth face on the upper side of the stationary-side sliding portion 44.

The U-shaped portion 73 is a portion with a substantially U-shaped cross-section profile (a cross-section profile orthogonal to the connector up-down direction). Namely, the U-shaped portion 73 is configured by a bottom plate portion 73A that is oriented with its plate thickness direction in the front-rear direction, and a pair of side plate portions 73B that extend forward from width direction ends of the bottom plate portion 73A. The pair of side plate portions 73B are both oriented with their plate thickness directions in the connector width direction, run parallel to each other, and face each other.

Latching projections 73BA are formed at the leading end side (front end side) of each of the pair of side plate portions 73B. The latching projections 73BA bite into an inner face of the movable housing 60, thereby press fitting the pair of side plate portions 73B of the movable terminal 70 into the movable housing 60 so as to be fixed thereto. Namely, the pair of side plate portions 73B function as second fixed portions that are fixed to the movable housing 60.

The movable-side sliding portion 71 and the U-shaped portion 73 are coupled together by a bent coupling portion 72. The coupling portion 72 couples a width direction central portion of a rear end of the movable-side sliding portion 71 to a width direction central portion of a lower end of the bottom plate portion 73A of the U-shaped portion 73.

The first fixed portion 77 is formed extending upward from a width direction central portion of an upper end of the bottom plate portion 73A of the U-shaped portion 73. Latching projections 77A are formed at each plate width direction side (each connector width direction side) of the first fixed portion 77. The latching projections 77A bite into an inner face of the movable housing 60, thereby press fitting the first fixed portion 77 of the movable terminal 70 into the movable housing 60 so as to be fixed thereto.

The movable terminal 70 includes a pair of spring tabs 78. The pair of spring tabs 78 extend upward from the upper ends of the pair of side plate portions 73B of the U-shaped portion 73. The spring tabs 78 each include an arm portion 74, the contact portion 75, and a guide portion 76 in this sequence on progression toward a leading end side.

The pair of arm portions 74 are inclined toward the connector width direction inside such that a gap therebetween gradually narrows on progression upward. Each of the arm portions 74 extends in a straight line. The plate width (the dimension along the connector front-rear direction) of each arm portion 74 gradually narrows on progression upward.

The pair of contact portions 75 are curved so as to protrude toward one another. The pair of contact portions 75 make contact from both connector width direction sides with a terminal portion 82 of the connection target 80 (see FIG. 11) that is inserted downward from above. The plate width of each contact portion 75 is the same as the plate width of the upper ends of the arm portions 74.

The pair of guide portions 76 are portions with a plate width (the dimension along the connector front-rear direction) that is comparatively larger than the plate width of the contact portions 75. The change in plate width from the contact portions 75 to the guide portions 76 is not a gradual increase, rather it is a sudden increase at the border between the contact portions 75 and the guide portions 76. Namely, the leading end portions of the arm portions 74 are T-shaped.

The movable-side sliding portion 71 has a rectangular shape with each of its sides oriented along either the connector width direction or the connector front-rear direction. The connector width direction (left-right direction) dimension of the movable-side sliding portion 71 is larger than the left-right direction dimension of the U-shaped portion 73. Accordingly, as illustrated in FIG. 8C, the majority of the pair of side plate portions 73B of the U-shaped portion 73 is hidden by the movable-side sliding portion 71 in bottom face view. Base portions of the pair of side plate portions 73B (boundary portions between the bottom plate portion 73A and the side plate portions 73B) are not hidden by the movable-side sliding portion 71 in bottom face view. The movable terminal 70 is press fit into the movable housing 60 by pushing these non-hidden portions of the movable terminal 70 upward from underneath.

Movable Housing 60

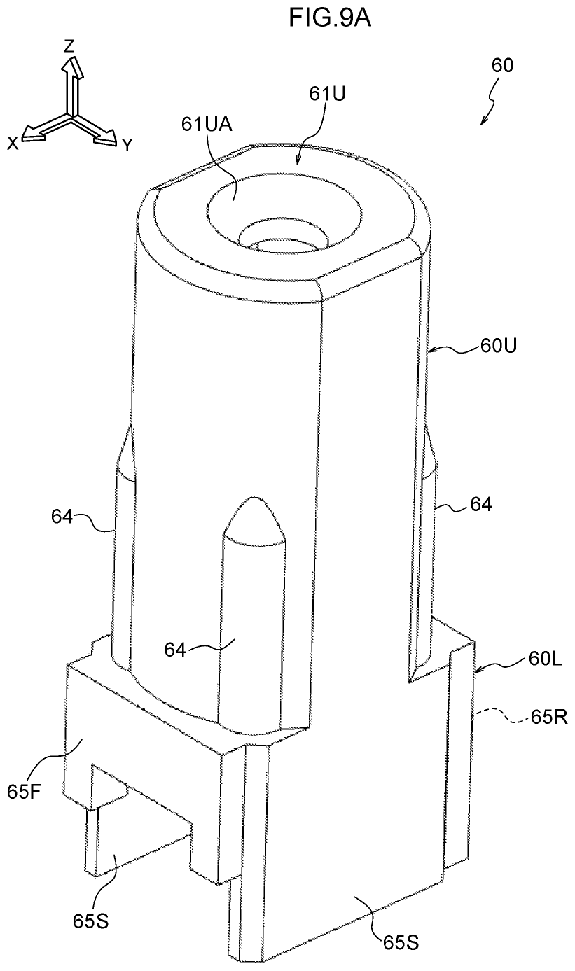

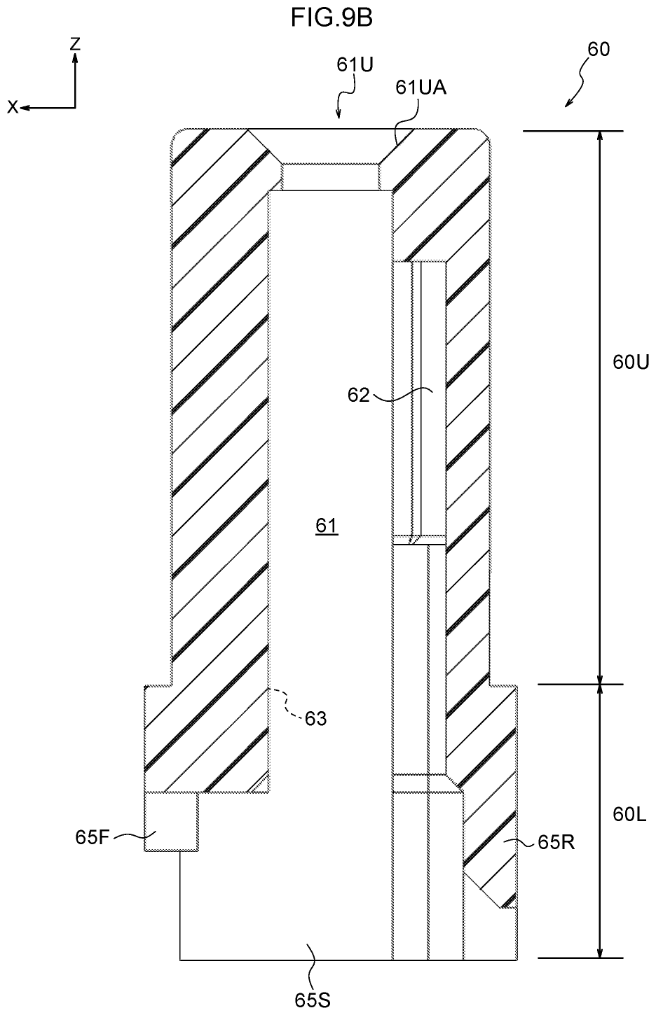

FIG. 9A and FIG. 9B illustrate the movable housing 60. The movable housing 60 is configured from an insulator such as a synthetic resin.

The movable housing 60 includes a retaining portion 61 that retains the movable terminal 70 (see FIG. 9B). Specifically, the movable housing 60 is tube shaped with its axial direction in the up-down direction, and the movable housing 60 retains the movable terminal 70 in the internally provided retaining portion 61 (see FIG. 1E).

As illustrated in FIG. 9B, the movable housing 60 includes a first fixing portion 62 into which the first fixed portion 77 of the movable terminal 70 is press fitted, and a second fixing portion 63 into which the pair of side plate portions 73B (second fixed portions) of the U-shaped portion 73 of the movable terminal 70 are press fitted. The first fixing portion 62 and the second fixing portion 63 are formed at the inside of the retaining portion 61.

An opposing-terminal insertion hole 61U is formed passing through an upper end of the retaining portion 61 in the up-down direction. The opposing-terminal insertion hole 61U has a circular shape. A tapered portion 61UA that leads the terminal portion 82 of the connection target 80 (see FIG. 11) into the retaining portion 61 is formed at an upper portion of the opposing-terminal insertion hole 61U.

As illustrated in FIG. 9A, looking at sections of the outer profile of the movable housing 60, the movable housing 60 is configured from an upper section 60U that has a substantially circular column shaped outer profile and a lower section 60L that has a substantially rectangular column shaped outer profile. Specifically, the outer profile of the upper section 60U of the movable housing 60 is configured with arcuate face shaped front and rear portions and with flat face shaped left and right portions. The upper section 60U of the movable housing 60 thus has a profile with a front-rear direction orientation, enabling the movable housing 60 to be positioned in a direction about an axis of rotation with respect to the movable shield 50.

Plural (four, in the present exemplary embodiment) protrusions 64 are formed protruding outward from an outer circumferential face of the movable housing 60. The protrusions 64 are formed to a lower side portion of the upper section 60U of the movable housing 60 and extend in the up-down direction. Press-contacting the protrusions 64 against an inner face of the movable shield 50 results in a state in which the movable housing 60 and the movable shield 50 are combined into an integral unit and do not readily separate from each other.

As illustrated in FIG. 9A, the lower section 60L of the movable housing 60 includes a front wall 65F, left and right side walls 65S, and a rear wall 65R. As illustrated in FIG. 3B, the movable-side sliding portion 71 of the movable terminal 70 is disposed within the retaining portion 61 in the lower section 60L of the movable housing 60. The two width direction sides of the movable-side sliding portion 71 make contact with the left and right side walls 65S of the lower section 60L of the movable housing 60.

The position of a lower end of the front wall 65F of the lower section 60L of the movable housing 60 is formed higher than that of the left and right side walls 65S. A front end portion of the movable-side sliding portion 71 (an end portion on the opposite side to that where the coupling portion 72 extends) makes contact with the lower end of the front wall 65F from the lower side (see FIG. 3B). Specifically, the position of the lower end of the front wall 65F is formed high toward a width direction center, and is formed lower toward both width direction outsides. The front end portion of the movable-side sliding portion 71 makes contact with the lower ends of width direction outside portions of the front wall 65F from the lower side.

Movable Shield

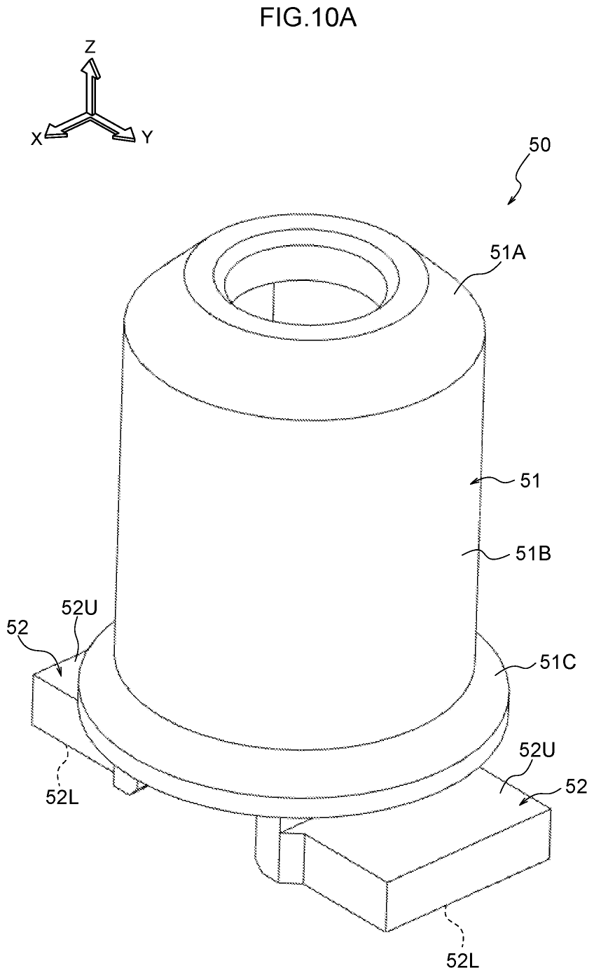

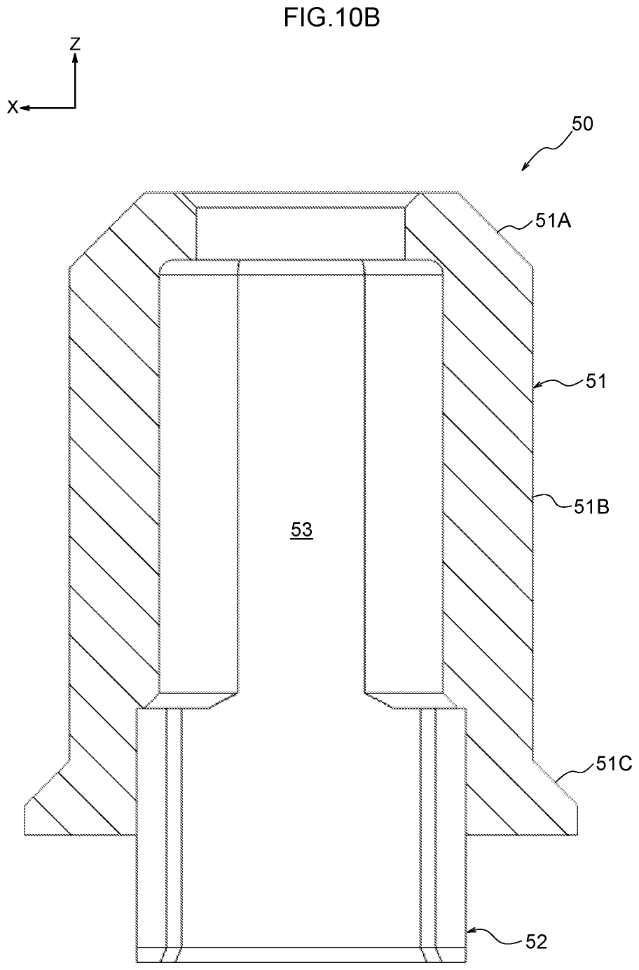

FIG. 10A to FIG. 10B illustrate the movable shield 50. The movable shield 50 is configured from a good conductor such as metal, and is die cast.

The movable shield 50 includes a tube shaped tubular portion 51 that circumferentially surrounds the movable housing 60, and the limited portions 52 located below the tubular portion 51.

The tubular portion 51 surrounds the movable terminal 70 from the connector front-rear and left-right directions, thereby functioning to shield the movable terminal 70. The movable shield 50 forms a unit with the movable housing 60 such that the movable housing 60 is covered by the tubular portion 51 (see FIG. 3B).

The limited portions 52 are portions that are restrained inside the gaps 92 (see FIG. 2C). By restraining the limited portions 52 inside the gaps 92, the range of movement of the movable-side member 14 is limited to a given range of motion with respect to the stationary-side member 12.

The tubular portion 51 has a circular tube shape, and as illustrated in FIG. 1E and FIG. 10B, includes an internal retaining portion 53 in which the movable housing 60 is retained. The retaining portion 53 is configured by a space that extends in the up-down direction. An upper end of the retaining portion 53 is open so as to enable insertion of the terminal portion 82 of the connection target 80, and a lower end of the retaining portion 53 is open so as to enable insertion of the movable housing 60.

The interior profile of the tubular portion 51 is shaped so as to fit together with the exterior profile of the movable housing 60. In a state in which the front-rear direction of the movable shield 50 and the front-rear direction of the movable housing 60 have been aligned, the movable shield 50 and the movable housing 60 can be combined into an integral unit.

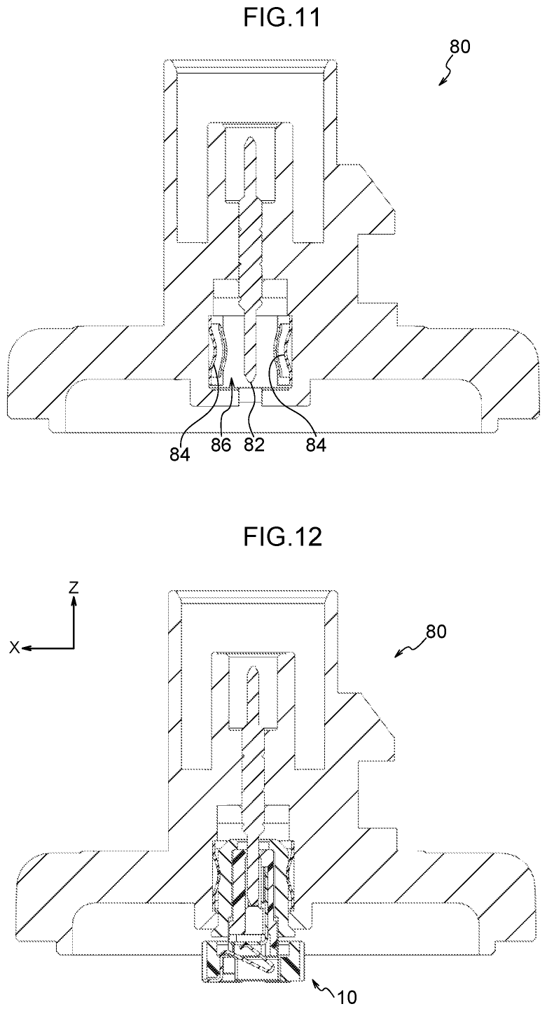

The exterior profile of the tubular portion 51 has a circular shape in plan view. In detail, an upper portion (tapered portion 51A) of the tubular portion 51 has a diameter that gradually decreases on progression upward, an up-down direction intermediate portion (vertical portion 51B) of the tubular portion 51 has a constant diameter and extends along the up-down direction, and a lower portion (skirt portion 51C) of the tubular portion 51 has a diameter that gradually increases on progression downward. The tapered portion 51A at the upper portion of the tubular portion 51 is capable of guiding shield connection portions 84 (see FIG. 11) of the connection target 80 toward the vertical portion 51B at the up-down direction intermediate portion of the tubular portion 51 in an appropriate manner (see FIG. 12).

The limited portions 52 are formed below the tubular portion 51. The limited portions 52 are formed on the left and right and project toward the left-right direction outsides. The limited portions 52 are disposed in the gaps 92 above the limiting face portion 32 of the stationary housing 30 and below the upper wall portions 23 of the fixing clips 20.

When the movable-side member 14 moves downward, lower faces 52L of the limited portions 52 abut the limiting face portion 32 of the stationary housing 30. When the movable-side member 14 moves upward, upper faces 52U of the limited portions 52 abut the upper wall portions 23 of the fixing clips 20. The range of up-down direction movement of the movable-side member 14 with respect to the stationary-side member 12 is thereby limited.

The limited portions 52 are formed in cuboidal shapes. The lower faces 52L of the limited portions 52 are configured as planar surfaces that have normals pointing in a downward direction, and the upper faces 52U of the limited portions 52 are configured as planar surfaces that have normals pointing in an upward direction.

Over a given range of motion (a range of motion limited by interference between the movable shield 50 and the stationary housing 30, and by interference between the movable shield 50 and the fixing clips 20), the movable-side member 14 is movable along the front-rear direction, the left-right direction, and the up-down direction with respect to the stationary-side member 12, and in this given range of motion, the movable-side member 14 is also capable of rotating about its up-down direction axis and capable of tilting its up-down direction axis.

The stationary-side contact portions 27 of the fixing clips 20 make contact with the lower faces 52L of the limited portions 52 (see FIG. 1D). The elastic spring sections 25 of the fixing clips 20 are accordingly elastically deformed downward. The stationary-side contact portions 27 thus press the limited portions 52 upward due to elastic force from the elastic spring sections 25. When the connector 10 is in an assembled state, the upper faces 52U of the limited portions 52 thereby adopt a state in contact with the upper wall portions 23 of the fixing clips 20.

Connection to Connection Target

FIG. 11 illustrates the connection target 80, and FIG. 12 illustrates a connection structure in which the connector 10 and the connection target 80 have been connected.

As illustrated in FIG. 11, the connection target 80 includes an insertion portion 86, this being a substantially circular tube shaped space into which the movable shield 50 of the connector 10 is inserted. The connection target 80 also includes the terminal portion 82, of which a leading end is disposed in the insertion portion 86, and the shield connection portions 84 that are disposed at side faces within the insertion portion 86.

As illustrated in FIG. 12, the connector 10 is connected to the connection target 80 by inserting the movable shield 50 of the connector 10 into the insertion portion 86 of the connection target 80. In a connected state, the pair of contact portions 75 of the connector 10 make contact with the terminal portion 82 of the connection target 80 from the connector horizontal direction, and the shield connection portions 84 of the connection target 80 make contact with the vertical portion 51B of the tubular portion 51 of the movable shield 50 of the connector 10 from the connector horizontal direction.

Operation and Advantageous Effects

Explanation follows regarding the operation and advantageous effects of the present exemplary embodiment.

In the present exemplary embodiment, the connector 10 includes the stationary housing 30 that is fixed to the substrate 90, and the movable housing 60 that is movable in the front-rear direction and the left-right direction with respect to the stationary housing 30. The stationary terminal 40 is retained at the stationary housing 30, and the movable terminal 70 is retained at the movable housing 60. The stationary terminal 40 and the movable terminal 70 are mutually in contact and achieving electrical continuity, and the movable terminal 70 includes the contact portions 75 that achieve electrical continuity with the terminal portion 82 of the connection target 80.

The stationary terminal 40 and movable terminal 70 slide against one another while maintaining electrical continuity when the movable housing 60 moves in the front-rear direction or the left-right direction with respect to the stationary housing 30. Namely, even when the movable housing 60 moves in either of two directions (the front-rear direction or the left-right direction) parallel to a planar surface of the substrate 90 with respect to the stationary housing 30, the stationary terminal 40 and the movable terminal 70 slide against one another while maintaining electrical continuity.

Specifically, the position of contact between the stationary terminal 40 and the movable terminal 70 moves (slides) over the smooth face at the lower side of the movable-side sliding portion 71 of the movable terminal 70 in the front-rear direction or the left-right direction.

Accordingly, stress is less liable to concentrate on the terminal, enabling damage to the terminal to be suppressed compared to a conventional connector in which all positional offset is absorbed by elastic deformation of an elastic portion when positional offset arises in either of two directions parallel to the planar surface of a substrate.

Moreover, since it is the smooth faces of the stationary terminal 40 and the movable terminal 70 that are in contact with each other, wear due to the stationary terminal 40 and the movable terminal 70 sliding against one another is less liable to arise, and stable electrical continuity is achieved between the stationary terminal 40 and the movable terminal 70, compared to cases in which plate thickness faces (punch-sheared faces) of the two are in contact with one another or cases in which a plate thickness face of one is in contact with a smooth face of the other.

Further, the contact portions 75 of the movable terminal 70 that achieve electrical continuity with the terminal portion 82 of the connection target 80 are in contact with the connection target 80 along a direction parallel to the planar surface of the substrate 90 (namely, along a direction orthogonal to the insertion direction of the connection target 80).

This enables the load borne by the substrate 90 accompanying connection of the connection target 80 to be reduced compared to a conventional connector in which the contact portions 75 make contact with the connection target from underneath, this being a direction orthogonal to the substrate 90, and receive downward direction (a direction orthogonal to the substrate) counterforce from the connection target to ensure contact pressure. This enables the connector 10 to be made less liable to warp the substrate 90 after being connected to the connection target 80.

Further, in the present exemplary embodiment, the connector 10 includes the upper limiting portion (the upper wall portions 23 of the fixing clips 20) that limits the range of upward direction movement (namely, the direction the connection target is removed) of the movable housing 60 with respect to the stationary housing 30. The upper limiting portion holds the stationary terminal 40 in an elastically deformed state at all times, and elastic force due to this elastic deformation acts along a direction keeping the stationary terminal 40 and the movable terminal 70 in pressing contact and achieving electrical continuity. This stabilizes the electrical continuity between the stationary terminal 40 and the movable terminal 70.

Further, since the upper limiting portion (the upper wall portions 23 of the fixing clips 20) is combined with the stationary housing 30 into an integral unit, load received by the upper limiting portion due to limiting the range of upward direction movement of the movable housing 60 is transmitted to the stationary housing 30.

As this load is upward load, downward load received by the stationary housing 30 from the movable terminal 70 through the stationary terminal 40 is cancelled out. As a result, the load transmitted toward the substrate 90 from the connector 10 is reduced.

Thus, in the present exemplary embodiment, electrical continuity between the stationary terminal 40 and the movable terminal 70 is stabilized, and warping of the substrate 90 is able to be prevented.

Further, in the present exemplary embodiment, the upper limiting portion that limits the range of upward direction movement of the movable housing 60 with respect to the stationary housing 30 is integrally formed as part of the fixing clips 20 for fixing the stationary housing 30 to the substrate 90. Thus, a mounting operation is simplified compared to configurations in which the upper limiting portion is formed separately from a member for fixing a stationary housing to a substrate.

Further, in the present exemplary embodiment, as for example illustrated in FIG. 8A, the movable-side sliding portion 71, this being the portion of the movable terminal 70 that makes contact with the stationary terminal 40, has its plate thickness direction in the up-down direction, and the U-shaped portion 73 is positioned above the movable-side sliding portion 71. The U-shaped portion 73 includes the bottom plate portion 73A and the pair of side plate portions 73B, and the bottom plate portion 73A is connected to the movable-side sliding portion 71. The contact portions 75 that make contact with the terminal portion 82 of the connection target 80 are formed in a pair at ends extending upward from the pair of side plate portions 73B so as to pinch and make contact with the terminal portion 82 of the connection target 80. A left-right direction (connector width direction, the direction in which the pair of side plate portions 73B face one another) dimension of the movable-side sliding portion 71 is greater than that of the U-shaped portion 73, enabling a large amount of left-right direction positional offset of the connection target 80 to be absorbed.

Further, in the present exemplary embodiment, as for example illustrated in FIG. 8A, the first fixed portion 77 that is press fitted and fixed to the movable housing 60 extends upward from the bottom plate portion 73A of the U-shaped portion 73. In a bottom face view looking at the movable terminal 70 from below, the base portions of the pair of side plate portions 73B of the U-shaped portion 73 are not hidden by the movable-side sliding portion 71. Accordingly, the first fixing portion 62 is able to be press fitted into the movable housing 60 in an appropriate manner by pushing the base portions of the pair of side plate portions 73B that are not hidden by the movable-side sliding portion 71 upward from the lower side of the movable terminal 70.

Further, in the present exemplary embodiment, the latching projections 73BA are formed at the leading end sides of the pair of side plate portions 73B. Accordingly, the pair of side plate portions 73B of the U-shaped portion 73 configure second fixed portions that are press fitted and fixed to the movable housing 60.

This enables wobble of the movable terminal 70 with respect to the movable housing 60 in a direction about an up-down direction axis of rotation to be suppressed.

Further, in the present exemplary embodiment, the guide portions 76 that have a greater width dimension than the contact portions 75 are formed further to the upper side than the contact portions 75, enabling the terminal portion 82 of the connection target 80 to be guided so as to achieve electrical continuity in an appropriate manner.

Further, in the connection structure in which the connector 10 of the present exemplary embodiment is connected to the connection target 80, the movable housing 60 is positioned at an upward limit position limited by the upper limiting portion (the upper wall portions 23 of the fixing clips 20), and so adopts a state in which upward load acts on the stationary housing 30 through the upper limiting portion. Downward load on the stationary housing 30 due to elastic force from the terminal is cancelled out by this load, thereby reducing load placed on the substrate by the stationary housing 30. This enables a connection structure in which the substrate 90 is not liable to warp.

Further, in the present exemplary embodiment, the connector 10 includes the stationary housing 30 and the movable housing 60. The stationary housing 30 is fixed to the substrate 90, and the movable housing 60 is movable with respect to the stationary housing 30 along the front-rear direction and the left-right direction, which are mutually orthogonal and run parallel to the planar surface of the substrate 90.

The stationary terminal 40, including the substrate-connected portion 41 that is connected to the substrate 90, is retained at the stationary housing 30, and the movable terminal 70 including the contact portions 75 that make contact with the terminal portion 82 of the connection target 80 are retained at the movable housing 60. The contact portions 75 are accordingly configured to follow the movement of the movable housing 60. The substrate-connected portion 41 and the contact portions 75 are also electrically connected.

Even if the position of (the terminal portion 82 of) the connection target 80 with respect to the substrate 90 is offset in a direction parallel to the planar surface of the substrate 90, this positional offset is able to be absorbed by the movable housing 60 moving with respect to the stationary housing 30 and by the contact portions 75 also moving so as to follow the movable housing 60.

Prevention of Stress Concentrating on Shield

Further, in the present exemplary embodiment, the connector 10 includes the movable shield 50 that makes contact with the shield connection portions 84 of the connection target 80, and the fixing clips 20 that are formed separately from the movable shield 50 and that make contact with the movable shield 50 and achieve electrical continuity therewith. When the movable housing 60 moves in a direction parallel to the planar surface of the substrate 90 with respect to the stationary housing 30, the fixing clips 20 and the movable shield 50 are configured to slide against one another while maintaining electrical continuity.

Thus, even if the position of (the shield connection portions 84 of) the connection target 80 with respect to the substrate 90 is offset in a direction parallel to the planar surface of the substrate 90, this positional offset is able to be absorbed by the movable housing 60 moving with respect to the stationary housing 30 and by the movable shield 50 moving so as to follow the movable housing 60. Moreover, since positional offset is absorbed by the sliding of the fixing clips 20 and the movable shield 50, situations in which stress is concentrated on the shield members (the fixing clips 20 and the movable shield 50), causing damage, are suppressed.

This combats the ingress and emission of electromagnetic noise, and enables the likelihood of damage to the connector 10 caused by concentrated stress to be reduced.

Further, in the present exemplary embodiment, the ingress and emission of electromagnetic noise is able to be efficiently prevented due to the tube shaped tubular portion 51 of the movable shield 50 surrounding the movable terminal 70 from the front-rear and left-right directions.

In the present exemplary embodiment, the ingress and emission of electromagnetic noise is able to be efficiently prevented.

Namely, for example, a movable shield may be configured from a punched, thin metal sheet, and this thin metal sheet made to cover the outer periphery of the movable housing to surround the movable terminal 70. However, it would be difficult to join together both end portions of the metal sheet in such a movable shield without any gaps therebetween, and so gaps may be formed at this joint. Further, even in cases in which a recess is formed in one end portion of a metal sheet and a protrusion is formed in the other end portion of the metal sheet and these two ends are joined together, slight gaps may still be present at this joint.

However, in the present exemplary embodiment, the movable shield 50 is die cast and is structured such that there are no joints in a circumferential direction position of the tubular portion 51 of the movable shield 50. This movable terminal 70 is thus able to be gaplessly surrounded. This enables the ingress and emission of electromagnetic noise to be efficiently prevented.

Further, the present exemplary embodiment enables the loss (interruption) of electrical continuity between the fixing clips 20 and the movable shield 50 to be suppressed.

Namely, when the movable housing 60 has moved with respect to the stationary housing 30, in particular when the movable housing 60 has received vibrations or a shock, there is a risk that the fixing clips 20 and the movable shield 50 will lose contact with each other and that noise will be emitted from the movable shield 50 and the fixing clips 20.

However, in the present exemplary embodiment, within the range of movement of the movable housing 60, the fixing clips 20 are in an elastically deformed state at all times, and this elastic force acts in directions causing the fixing clips 20 and the movable shield 50 be in pressing contact and achieve electrical continuity.

This enables the loss (interruption) of electrical continuity to be suppressed after receiving vibration or shock, enabling the connector 10 to be well-equipped to handle noise.

Further, the present exemplary embodiment enables the likelihood of damage to the elastic spring sections 25 of the fixing clips 20 to be reduced.

Namely, were the elastic spring sections 25 to be used to abut the limited portions 52 of the movable shield 50 from the lower side and limit downward direction movement of the movable housing 60 during downward direction movement of the movable housing 60, the elastic spring sections 25 would be at risk of plastically deforming and snapping due to being unable to cope with the pressing force received.

However, in the present exemplary embodiment, the upper wall portions 23 (upper limiting portions) of the fixing clips 20 limit movement when the movable housing 60 moves upward, and the limiting face portion 32 of the stationary housing 30 limits movement when the movable housing 60 moves downward. This prevents excessive load from acting on the fixing clips 20. Thus, damage to the elastic spring sections 25 of the fixing clips 20 is able to be suppressed.

Further, even while the limiting face portion 32 abuts the limited portions 52, the stationary-side contact portions 27 of the elastic spring sections 25 maintain elastic contact with the limited portions 52 from the lower side through the openings in the recesses 33 despite being fit inside the recesses 33. This enables the electrical continuity between the fixing clips 20 and the movable shield 50 to be stably maintained.

Additional Explanation

Note that although the above exemplary embodiment was explained using an example in which the connector 10 includes the movable shield 50, the present invention is not limited thereto. For example, the movable shield 50 of the exemplary embodiment may be configured by an insulating body that does not include a shield function. Alternatively, for example, a single movable housing may be configured by integrally molding a member with substantially the same shape as the movable housing 60 and the movable shield 50 when combined as an integral unit using an insulating body.

Further, the exemplary embodiment was explained using an example in which within the range of movement of the movable housing 60 (movable-side member 14), (elastic spring sections 25 of) the fixing clips 20 are held in an elastically deformed state at all times, and elastic force due to this elastic deformation secures the contact pressure between the fixing clips 20 and the movable shield 50, whereas the movable shield 50 is die cast and does not elastically deform. However, configuration may be made such that part of the movable shield 50 is formed so as to be capable of elastic deformation, and within the range of movement of the movable housing 60 (movable-side member 14), this part of the movable shield 50 is in an elastically deformed state at all times so as to secure contact pressure between the movable shield 50 and the fixing clips 20.

Further, the exemplary embodiment was explained using an example in which within the range of movement of the movable housing 60 (movable-side member 14), the stationary terminal 40 is held in an elastically deformed state at all times, and the elastic force due to this elastic deformation secures contact pressure between the stationary terminal 40 and the movable terminal 70. However, configuration may be made such that within the range of movement of the movable housing 60 (movable-side member 14), a movable terminal is held in an elastically deformed state at all times, and the elastic force due to this elastic deformation secures contact pressure between a stationary terminal and the movable terminal.

Further, although the exemplary embodiment was explained using an example in which elastic force from part (the elastic spring sections 25) of the fixing clips 20 elastically contacts part (the limited portions 52) of the movable-side member 14 from the lower side, configuration may be made such that elastic force from part of a stationary shield elastically contacts part of a movable-side member from the upper side. For example, elastic spring sections may be formed to parts of the upper wall portions 23 of the fixing clips 20, and these made to elastically contact limited portions from the upper side, and portions of the elastic spring sections 25 of the exemplary embodiment may be configured as lower limiting portions formed such that they do not readily elastically deform (as portions that abut the movable-side member from the lower side so as to limit the range of downward direction movement of the movable-side member).

In such cases also, the limited portions of the movable shield are sandwiched between the lower limiting portions and other parts of the stationary shield in the up-down direction so as to make elastic contact therewith and provide stable electrical continuity between the fixing clips 20 and the movable shield 50.

Further, although the exemplary embodiment was explained using an example in which the movable housing 60 (movable-side member 14) was able to move within a given range of motion in the connector up-down direction, configuration may be such that the movable housing 60 (movable-side member 14) is unable to move up and down with respect to the connector.

### EXPLANATION OF REFERENCE NUMERALS

10 connector
20 fixing clip
23 upper wall portion (upper limiting portion, limiting portion)
25 elastic spring section
26 elastic support portion
27 stationary-side contact portion
30 stationary housing
32 limiting face portion
33 recess
36 sloping face
40 stationary terminal
41 substrate-connected portion
44 stationary-side sliding portion
52 limited portion
60 movable housing
70 movable terminal
71 movable-side sliding portion
73 U-shaped portion
73A bottom plate portion
73B side plate portions
75 contact portion
76 guide portion
77 first fixed portion
80 connection target
82 terminal portion
84 shield connection portions
90 substrate

The entire content of the disclosure of Japanese Patent Application No. 2017-140987 filed on Jul. 20, 2017 is incorporated by reference in the present specification.

1. A connector comprising:
a stationary housing configured to be fixed to a substrate;
a movable housing that is movable in a front-rear direction and a left-right direction with respect to the stationary housing, the front-rear direction and the left-right direction being mutually orthogonal and running parallel to a planar surface of the substrate;
a stationary terminal that is retained at the stationary housing; and
a movable terminal that is formed separately from the stationary terminal and retained at the movable housing, and that includes a contact portion configured to achieve electrical continuity with a connection target inserted in a downward direction that is a direction toward the substrate out of directions orthogonal to the planar surface of the substrate,
the stationary terminal and the movable terminal being mutually in contact and achieving electrical continuity,
the stationary terminal and the movable terminal being configured to slide against one another while maintaining electrical continuity when the movable housing moves in the front-rear direction or the left-right direction with respect to the stationary housing, and
the contact portion being configured to contact the connection target from a direction parallel to the planar face of the substrate.

2. The connector of claim 1, wherein:
the connector includes an upper limiting portion that limits a movement range of the movable housing with respect to the stationary housing in an upward direction that is a direction to remove the connection target;
the upper limiting portion is integrally formed with the stationary housing; and
at least one of the stationary terminal or the movable terminal is held in an elastically deformed state at all times by the upper limiting portion, with elastic force due to the elastic deformation acting along a direction to place the stationary terminal and the movable terminal in pressing contact so as to achieve electrical continuity.

3. The connector of claim 2, further comprising a fixing clip configured to fix the stationary housing to the substrate, the upper limiting portion being integrally formed as part of the fixing clip.

4. The connector of claim 1, wherein:
the movable terminal includes:
a movable-side sliding portion configured by a portion of the movable terminal that slides against the stationary terminal and has a plate thickness direction along an up-down direction, and
a U-shaped portion with a U-shaped cross-section profile that is positioned above the movable-side sliding portion, and that includes a bottom plate portion connected to the movable-side sliding portion and a pair of side plate portions;
contact portions are formed as a pair, at leading end sides extending upward from the pair of side plate portions so as to pinch and make contact with the connection target; and
the movable-side sliding portion has a greater dimension than the U-shaped portion in the left-right direction that is a direction in which the pair of side plate portions face one another.

5. The connector of claim 4, wherein:
the movable terminal further includes a first fixed portion that extends upward from the bottom plate portion of the U-shaped portion and is press fitted and fixed to the movable housing; and
base portions of the pair of side plate portions of the U-shaped portion are not hidden by the movable-side sliding portion when the movable terminal is viewed from below.

6. The connector of claim 4, wherein:
latching projections are formed at leading end sides of the pair of side plate portions; and
the pair of side plate portions of the U-shaped portion configure second fixed portions that are press fitted and fixed to the movable housing.

7. The connector of claim 1, wherein a pair of guide portions that have a greater plate width dimension than the contact portions are formed further toward an upper side than the contact portions.

8. A connection structure comprising:
the connector of claim 2; and
the connection target connected to the connector,
the movable housing being positioned at an upward limit position by the upper limiting portion.
